(19) United States
(12) Patent Application Publication
(10) Pub. No.: US 2025/0210928 A1
(43) Pub. Date: Jun. 26, 2025

(54) WAVEGUIDE AMPLIFIER AND WAVEGUIDE AMPLIFIER FABRICATION METHOD

(71) Applicant: ECOLE POLYTECHNIQUE FEDERALE DE LAUSANNE (EPFL), Lausanne (CH)

(72) Inventors: Tobias KIPPENBERG, St-Sulpice (CH); Yang LIU, Chavannes-Renens (CH); Zheru QIU, Crissier (CH); Xinru JI, Ecublens (CH)

(21) Appl. No.: 18/848,304

(22) PCT Filed: Mar. 23, 2022
(86) PCT No.: PCT/IB2022/052668

§ 371 Date: Sep. 18, 2024

(51) Int. Cl. H01S 3/063; H01S 3/067; H01S 3/0941; H01S 3/16

(52) U.S. Cl. CPC H01S 3/0637; H01S 3/06716; H01S 3/09415; H01S 3/1608; H01S 3/1616; H01S 3/1618

(57) ABSTRACT

The present invention concerns a waveguide amplifier comprising: —at least one embedding cladding material or layer, and—at least one rare-earth ion implanted silicon nitride material or layer embedded in the at least one embedding cladding material or layer, the at least one rare-earth ion implanted silicon nitride material or layer defining a waveguide core enclosed by the at least one embedding cladding material or layer.

### FIELD OF THE INVENTION

The present invention relates to a waveguide amplifier device and a waveguide amplifier fabrication method, as well as to a photonic integrated circuit based rare earth doped amplifier and a fabrication method thereof.

### BACKGROUND

Erbium-doped fiber amplifiers have revolutionized long-haul optical communications and laser technology. Erbium ions could equally provide a basis for efficient optical amplification in photonic integrated circuits. However, this approach has thus far remained impractical due to insufficient output power.

The innovation of erbium-doped fiber amplifiers (EDFAs) in the 1980s (1, 2) has revolutionized long-haul optical communications and profoundly impacted our information society. EDFAs have replaced the complex and bandwidth-limited electrical repeaters, enabling transatlantic fiber-based optical communication networks (3). Erbium amplifiers have a number of unique properties highly suitable for optical communications, such as the broadband gain around 1550 nm that coincides with the lowest optical fiber propagation loss band, a long ms-lifetime of the parity forbidden intra-4-f shell ⁴I_{15/2}-⁴I_{13/2} transition that leads to slow gain dynamics and negligible inter-channel crosstalk in multi-wavelength amplification, high temperature stability, and low noise figure approaching the quantum mechanical limit of 3 dB for phase insensitive amplification (4).

Today, EDFAs have underpinned the development of narrow-linewidth and mode-locked lasers that are widely deployed in applications such as coherent communications (3), interferometric sensing and optical frequency metrology (5). Rare-earth ion doping (6, 7) can equally provide the basis for compact erbium-doped waveguide amplifiers (EDWAs) (8). Indeed, pioneering efforts in the 1990s have been made to implement EDWAs based on oxide glass waveguides (9.10). Yet, these approaches were limited by large waveguide background losses, large device footprints and incompatibility with contemporary photonic integrated circuits (11), and ultimately abandoned. Interest in EDWAs re-emerged with the Si₃N₄ CMOS-compatible photonic integrated circuit platform, with advantages over silicon including its wider transparency window (12), absence of two-photon absorption in telecommunication bands, a lower temperature sensitivity, high power handling of up to tens of Watts (13), and—most crucially—record low propagation losses of only <3 dB/m that can be maintained over meter-scale lengths (14).

One challenge in realizing photonic integrated circuit based erbium amplifiers is the limited gain that can be achieved stemming from constraints in doping concentration due to cooperative upconversion (15). This limitation necessitates waveguides with low propagation loss and long waveguides with 10 s of centimeter to meter lengths, to achieve a large gain and a high output power, which has been challenging in integrated photonics. While net (and very significant) gain has been shown, all prior work so far using materials such as erbium-doped Al₂O₃ (16.17) and TeO₂ (18) achieved only very limited output powers of typically <1 mW. Despite high doping concentrations, past attempts using atomic layer deposition of Al₂O₃ and Er₂O₃ layers (17) or single-crystal erbium chloride silicate nanowire (19) only deliver <<1 μW output power. Such output power is far below the level demanded by many applications, i.e., in the range of 10-100 mW that has been achieved with heterogeneous integration of III-V amplifiers onto silicon photonics (20-22).

### SUMMARY OF THE INVENTION

The present invention addresses the above-mentioned limitations by providing a photonic integrated circuit waveguide amplifier according to claim 1, and a Photonic integrated circuit waveguide amplifier fabrication method according to claim 48. This waveguide amplifier assures an output power demanded by multiple applications.

Other advantageous features can be found in the dependent claims.

The present disclosure demonstrates waveguide amplifier, for example, a photonic integrated circuit-based erbium amplifier reaching 145 mW output power and more than 30 dB small-signal gain-on par with commercial fiber amplifiers and beyond state-of-the-art III-V heterogeneously integrated semiconductor amplifiers. This is achieved by applying ion implantation to Si₃N₄ photonic integrated circuits, for example, ultralow-loss Si₃N₄ photonic integrated circuits that may, for example, have meter-scale-length waveguides. The device according to the present disclosure is used, for example, to increase by 100-fold the output power of soliton microcombs, required for low-noise photonic microwave generation or as a source for wavelength-division multiplexed optical communications.

Endowing Si₃N₄ photonic integrated circuits with gain enables the miniaturization of a wide range of fiber-based devices such as high-pulse-energy femtosecond mode-locked lasers.

One exemplary waveguide amplifier according to the present disclosure concerns a photonic integrated circuit based Er:Si₃N₄ waveguide amplifier that can provide up to 145 mW on-chip output power and a small-signal gain of more than 30 dB. The design freedom afforded by photonic integrated circuits allows multi-stage configurations to be adopted, in order to optimize the gain and the optical signal-to-noise ratio.

Moreover, the ion implantation technique of the waveguide amplifier fabrication method of this disclosure could allow for co-doping other rare-earth ions with erbium ions such as ytterbium (emission at 1.1 μm) and thulium (0.8 μm, 1.45 μm and 2.0 μm), thereby additionally providing gain in other wavelength regions.

The disclosed method of ion implantation in Si₃N₄ can serve as the gain medium in a variety of integrated laser sources such as high-power soliton microcombs, low-noise rare-earth-ion-based CW lasers, femtosecond mode-locked lasers (28) or cavity soliton lasers (29). Equally important, this active Si₃N₄ photonic platform is compatible with heterogeneous integration of thin-films such a thin film lithium niobate, enabling the combination of both high-speed electro-optical modulation and amplification on the same chip, of use for coherent communications (27) or radio-frequency distribution (30).

The above and other objects, features, and advantages of the present invention and the manner of realizing them will become more apparent, and the invention itself will best be understood from a study of the following description with reference to the attached drawings showing some preferred embodiments of the invention.

### A BRIEF DESCRIPTION OF THE SEVERAL VIEWS OF THE DRAWINGS

FIG. 1A shows an exemplary waveguide amplifier of the present disclosure shown as an integrated erbium-implanted Si₃N₄ waveguide amplifier and as an exemplary integrated active Si₃N₄ photonic circuit for lasers and optical amplification, leveraging erbium-implanted Si₃N₄ waveguides, ultralow-loss passive circuits and Kerr nonlinear devices. The inset shows the optical amplification process of erbium ions excited by the 1480 nm pump.

FIG. 1B is an optical image of an exemplary 0.5-m-long Er:Si₃N₄ waveguide coil.

FIG. 1C shows profiles of a calculated erbium concentration comprising three successive ion implants (dashed lines) using SRIM simulations, the simulated optical transverse electric (TE) mode intensity and the measured erbium concentration by Rutherford backscattering spectrometry (RBS), along the vertical cutline indicated by the arrows in the inset. The inset shows the SEM image of the waveguide cross section overlaid with the simulated fundamental TE mode.

FIG. 1D shows measured optical losses of a Si₃N₄ waveguide before implantation, as-implanted, and after annealing. The inset shows the background loss around 1610 nm with weak erbium absorption.

FIG. 1E is an optical image of the exemplary Er:Si₃N₄ chip with waveguides butt-coupled with two optical fibers. The green light emission (bottom coil) the results from the second-order cooperative upconversion process upon intense optical pumping.

FIG. 2A shows light emission and absorption properties of Er:Si₃N₄ photonic waveguides and shows fluorescence emission spectrum (right) of an exemplary 0.46-cm-long Er:Si₃N₄ waveguide upon 980 nm pumping (left), via the emission transition among energy levels illustrated by the inset.

FIG. 2B shows measured resonance linewidths of an exemplary Er:Si₃N₄ microring resonator used for characterizing the wavelength-dependent erbium absorption. The insets exemplify two resonances at the wavelengths indicated by arrows.

FIG. 2C shows emission and absorption cross sections converted from the measured fluorescence and absorption spectra.

FIG. 2D shows an experimental setup for fluorescence lifetime measurement. A continuous-wave 980 nm laser gated at 20 Hz with 50% duty cycle is used to pump the Er:Si₃N₄ waveguide (very weakly coupled with a microring resonator). AFG, arbitrary function generator; FPC, fiber-based polarization controller; LPF, optical low pass filter; PD, photodetector; OSC, electrical oscilloscope.

FIG. 2E shows measured fluorescence decay from the ⁴I_{13/2} level. The inset shows the gated pump and emission.

FIG. 2F shows measured net gain per centimeter in the exemplary Er:Si₃N₄ waveguides with different erbium concentrations upon 1480 nm pumping. The top shaded area indicates the on-chip net gain regime after excluding the erbium absorption and the waveguide loss.

FIG. 3A shows an experimental setup for measuring the optical amplification in an exemplary spiral Er:Si₃N₄ waveguide amplifier. A free-space low pass filter is used to isolate the residual pump for amplification analysis. FPC, fiber-based polarization controller; ATT, tunable optical attenuators; PM, power meter; LPF, optical low-pass filter; OSA, optical spectrum analyzer.

FIG. 3B shows measured wavelength-dependent on-chip net gain. The solid line indicates the average value of the gain obtained with 0.07 mW on-chip signal input at a total on-chip pump power of 245 mW.

FIG. 3C shows measured (scatters) and simulated (solid curves) on-chip gain for signals at 1550 nm. Areas indicate the regions for off-chip net gain, as well as the loss contributions from fiber-to-chip coupling loss, waveguide background loss and erbium absorption, respectively.

FIG. 3D shows the corresponding on-chip output powers at 1550 nm. The inset shows the calibrated optical spectrum of the 145 mW signal output after amplification.

FIG. 4A shows broadband on-chip amplification of soliton microcombs for low-noise microwave generation and optical communication carriers and in particular the experimental setup for broadband soliton amplification using an exemplary integrated Er:Si₃N₄ waveguide. ECDL, external cavity diode laser; FBG, fiber Bragg grating; PM, power meter; OSA, optical spectrum analyzer; ESA, electrical spectrum analyzer.

FIG. 4B is a stitched optical image of a 19.8 GHz Si₃N₄ race-track microring resonator.

FIG. 4C shows transmission with soliton steps during laser scanning a resonance.

FIG. 4D shows amplification of 19.8 GHz microcomb in C- and L-band where the top section (i) shows the generated single-soliton state microcomb as the input, the middle section (ii) shows the amplified microcomb by the Er:Si₃N₄ EDWA, and bottom section (iii) shows the amplified microcomb by a commercial EDFA (Calmar Laser AMP-STY). The dashed curves indicate input microcomb envelope. The spectral power is calibrated.

FIG. 4E shows the corresponding single-sideband (SSB) phase noises of generated microwave signals. The ‘step-like’ noise feature is due to the analyzer noise floor indicated by the dashed line.

FIG. 4F shows the optical spectra of amplified 100 GHz soliton microcomb (36 mW) and the input (0.12 mW). The corresponding 24.8 dB net gain allows for achieving a maximum comb line power of >1 mW in the optical communication C-band.

FIG. 5A shows a preferred exemplary waveguide amplifier fabrication method according to the present disclosure where an exemplary Er:Si₃N₄ photonic chip fabrication is shown. The materials indicated and details indicated in the various steps are exemplary. The exemplary Er:Si₃N₄ (PIC) fabrication process uses the Si₃N₄ photonic Damascene process (generally shown as those steps inside dashed line box), and furthermore comprises ion implantation and ion (e.g. erbium) activation.

FIG. 5B shows a false colored SEM image of an exemplary Si₃N₄ waveguide cross section produced after the annealing Step 6 of FIG. 5A, prior to the ion implantation and annealing after implantation.

FIG. 5C shows a false colored SEM image of a Si₃N₄ waveguide produced after Step 8, i.e. post implantation annealing for rare earth (erbium) activation and defect recovery, for example, at 1000° C.

FIG. 5D shows a false colored SEM image of a Si₃N₄ waveguide after a different post implantation annealing at 1200° C. These cross-sectional samples were briefly treated in buffered HF for ˜ 10 s to create topography contrast under SEM.

FIG. 6 shows geometry characterizations of Si₃N₄ waveguides without a lateral cladding before and after erbium implantation, where (a) is a SEM image of the Si₃N₄ ridge waveguide cross section before ion implantation; (b) is a SEM image of the Si₃N₄ ridge waveguide cross section after irradiation; (c) is a tilted top-down view SEM image of the boundary region between the irradiated waveguide segment and the non-irradiated segment masked by a droplet of wax (Quickstick 135), the masking wax was only partially removed in heated acetone after irradiation; (d) shows surface topography of (a) measured by atomic force microscopy (AFM); (e) shows surface topography of (b) measured by AFM; (f) shows a line profile of (d) and (e) in a plane normal to the waveguide axis.

FIG. 7A shows a selectively erbium implanted Si₃N₄ photonic circuit where FIG. 7A is a dark field optical microscope image of an exemplary selectively implanted photonic circuit. The region surrounding and containing a ring resonator is masked (not-implanted) while a neighboring area with a spiral coil is implanted. The total implantation dose of this sample is around 1×10¹⁶ cm⁻².

FIG. 7B shows a top surface topography of a Si₃N₄ section near the boundary between masked area and the implanted area, mapped by AFM.

FIG. 7C shows a line profiles of FIG. 7b perpendicular to the boundary.

FIG. 7D shows a line profile of FIG. 7B parallel to the boundary, crossing the 2 μm wide implanted Si₃N₄ region.

FIGS. 8A to 8C show Rutherford backscattering spectroscopy measurement and analysis, where FIG. 8A shows part of the measured RBS spectra representing the elements of the matrix together with simulated RBS spectra; FIG. 8B shows part of the RBS spectra highlighting the erbium signal together with a multi-layer simulated spectrum, and FIG. 8C shows an extracted measured Er concentration profile (solid line) together with the respective SRIM simulation of the implantation profile.

FIGS. 9A to 9E show Er:Si₃N₄ waveguide loss characterization, where FIG. 9A shows normalized transmission of a 100 GHz Si₃N₄ microring resonator before erbium implantation; FIG. 9B shows normalized transmission of a 100 GHz FSR Er:Si₃N₄ microring resonator after 1000° C. annealing for erbium activation and loss recovery; FIG. 7C shows an intrinsic linewidths (κ₀/2π) of the annealed Er:Si₃N₄ microring resonator; FIG. 9D shows waveguide losses extracted from the intrinsic linewidths; and FIG. 9E shows waveguide losses obtained from the OFDR measurement in the 0.5-m-long Er:Si₃N₄ waveguide spiral.

FIGS. 10A and 10B show signal gain dependence on the pump wavelength and the waveguide width where FIG. 10A shows measured signal enhancement per centimeter Er:Si₃N₄ waveguide upon pumping at 980 nm and 1480 nm; and FIG. 10B shows measured signal enhancement per centimeter for 1.8 μm, 2.1 μm, and 2.4 μm wide waveguide upon 1480 nm pumping; Solid dots are measurements and lines are guides for the eye created by smoothing spline. The samples are doped with ˜ 1.35×10²⁰ cm⁻³ cm peak concentration.

FIGS. 11A and 11B show energy levels and up-conversion transitions in Er:Si₃N₄, where FIG. 11A shows a scheme of energy level of Er³⁺ ions in solids and important transitions in between. Non-radiative relaxation are omitted for clearness. Transitions labeled; (1) 980 nm pump, (2) 1480 nm pump, (3) excited state absorption (ESA) of 980 nm pump, (4) cooperative up-conversion from ⁴I_{11/2}, (5) cooperative up-conversion from ⁴I_{13/2}, (6) Green emission at 520 nm/545 nm, (7) Red/NIR emission at 665 nm/800 nm, (8) 845 nm emission, (9) 980 nm emission, (10) 1530 nm emission used for C-band optical amplification [134, 135]. FIG. 11B shows measured optical spectrum (intensity uncalibrated) of multi-step up-converted luminescence emitted by the Er:Si₃N₄ spiral waveguide under intense 1480 nm pump. Featuring emission (6) and partially (7). The weak emission at 410 nm may be attributed to a three step up-conversion to a higher level ²H_{9/2}[133, 134].

FIG. 12A to 12C show measured and numerical fitted optical amplification in Er:Si₃N₄ spiral waveguides, where FIG. 12A shows measured (scatters) and simulated (solid curves) on-chip net gain for signals at 1550 nm in the 50-cm-long Si₃N₄ waveguide doped with 1.35×10²⁰ cm⁻³ erbium concentration; FIG. 12B shows the corresponding on-chip output powers at 1550 nm, the inset shows the calibrated optical spectrum of the 55 mW signal output at a pump power of ˜120 mW at 1480 nm; FIG. 12C shows on-chip net gain as a function of input signal power at 1550 nm for two Er:Si₃N₄ waveguide amplifiers with different erbium concentrations. The shaded area indicates the regime where parasitic lasing takes place when the net gain exceeds ˜26 dB.

FIG. 13 shows calculation of on-chip net gain under various pump powers at 1480 nm and different waveguide lengths for-10 dBm on-chip input signal at 1550 nm. Based on experimentally extracted cross sections and fitted parameters, the achievable on-chip net gain is calculated in an Er:Si₃N₄ with the length varied from 5 mm to 1 m with an on-chip forward pump power of up to 1 W. The star marker indicates the regime around which the Er:Si₃N₄ waveguide amplifier can approach in the presented demonstrations. Further increase in optical gain can be achieved by deploying higher pump powers or reducing the coupling loss.

FIGS. 14A to 14D show reduction of Fresnel reflection and parasitic lasing, where FIG. 14A shows normalized transmission of a passive Si₃N₄ microring resonator side coupled with a bus waveguide with a length of 0.5 cm. A pair of lensed fibers are used for light coupling to the chip, with air gaps. The calculated Fresnel reflection is 4.77%. FIG. 14B shows measured optical spectra and the projection of the CW signal amplified by a 0.5-m-long Er:Si₃N₄ waveguide interfaced with lensed fibers. Parasitic lasing is clearly observed with >10 mW on-chip pump power. FIG. 14C shows normalized transmission of a passive Si₃N₄ microring resonator side coupled with a bus waveguide with a length of 0.5 cm. A pair of UHNA fibers have close contact with the waveguide facets for light coupling, and the gaps are filled with refractive index matching gel. The calculated Fresnel reflection is 0.5%. FIG. 14D shows measured optical spectra and the projection of the CW signal amplified by a 0.5-cm-long Er:Si₃N₄ waveguide coupled to UHNA fibers with refractive index matching gel applied. Parasitic lasing is suppresed. The input signal power is kept constant at ˜−10 dBm for both cases.

FIGS. 15A and 15B show noise figure characterization, where FIG. 15A shows a measured noise figure of the 21-cm-longEr:Si₃N₄ waveguide amplifier under various on-chip pump powers and off-chip input powers at 1550 nm. The star marker indicates the pump and signal conditions for the example noise figure measurement. FIG. 15B shows optical spectra of the input signal and the amplified signal used for deriving the noise figure using the optical source-subtraction method [137] after power calibration.

FIG. 16 shows an exemplary application of an Er:Si₃N₄ EDWA for short-reach WDM coherent communications. The Er:Si₃N₄ EDWA (can be co-integrated with Kerr microrings) is used to amplify the low-power soliton microcomb with tens of mW output power for a WDM communication transmitter, exhibiting significant footprint reduction compared to the case using bench-top EDFAs. The output of the EDWA could be used for short-reach communication applications such as intra-data-center communications with <1 km optical fiber link. EDWAs can also be inserted at the output of the transmitter or the receiver front-end.

FIGS. 17A to 17B show exemplary embodiments of the amplifier according to the present disclosure. FIGS. 17A and 17B show exemplary cross-sectional views while FIG. 17C shows a perspective view.

FIG. 18 shows ion implantation carried out through a covered outer surface of the silicon nitride material, for example, covered by cladding layer or material.

FIGS. 19A to 19D show further exemplary embodiments of the photonic integrated circuit waveguide amplifier.

Herein, identical reference numerals are used, where possible, to designate identical elements that are common to the Figures.

### DETAILED DESCRIPTION OF SEVERAL EMBODIMENTS

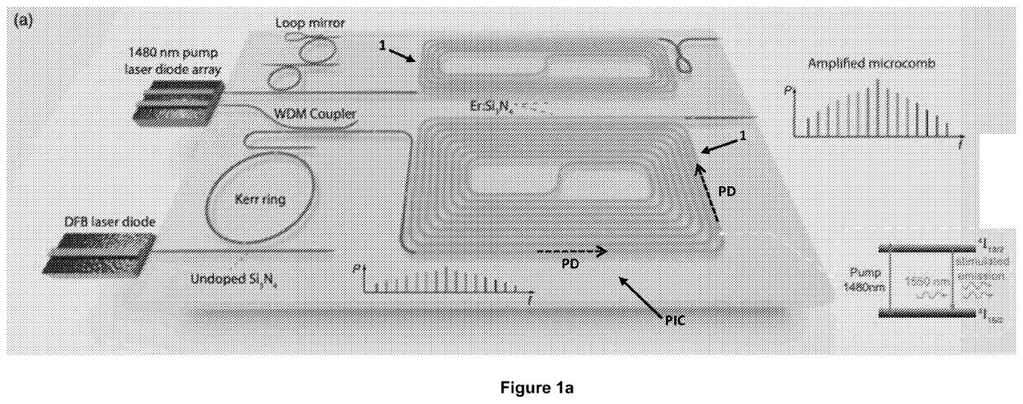

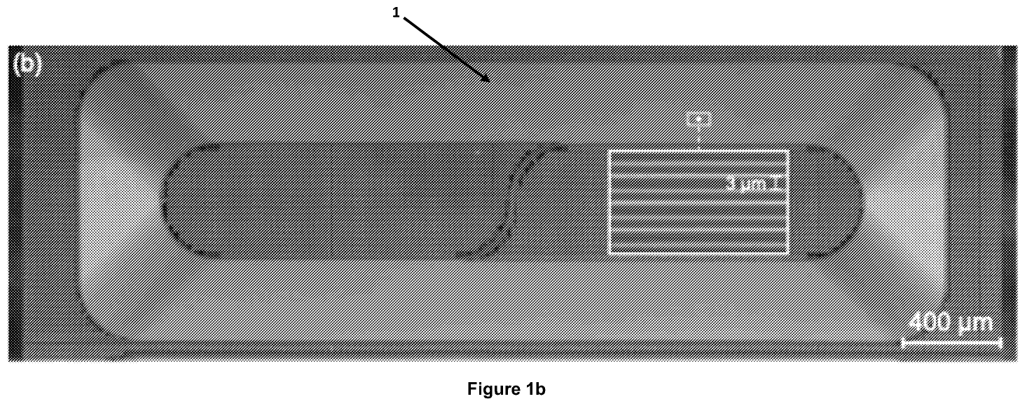

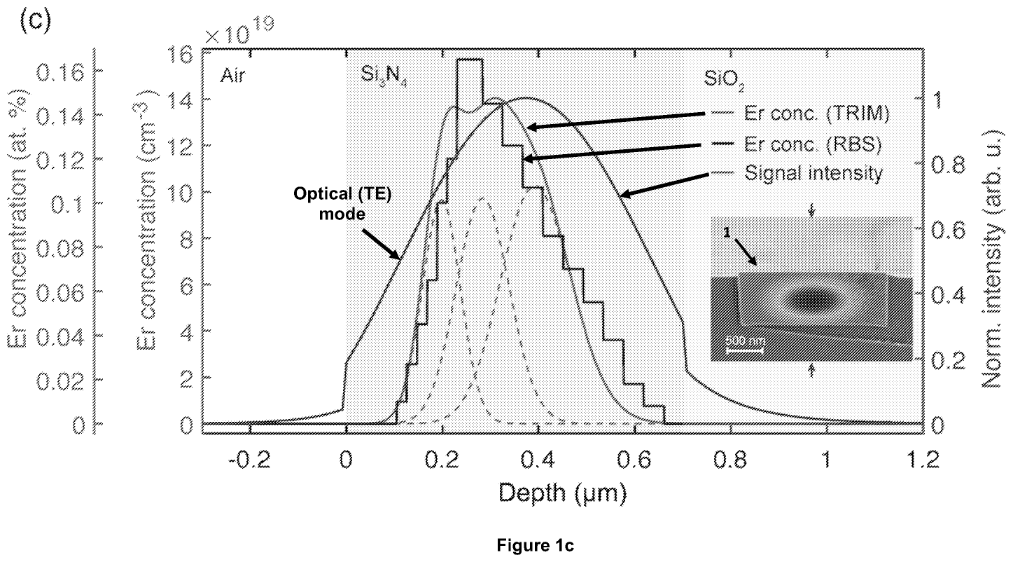

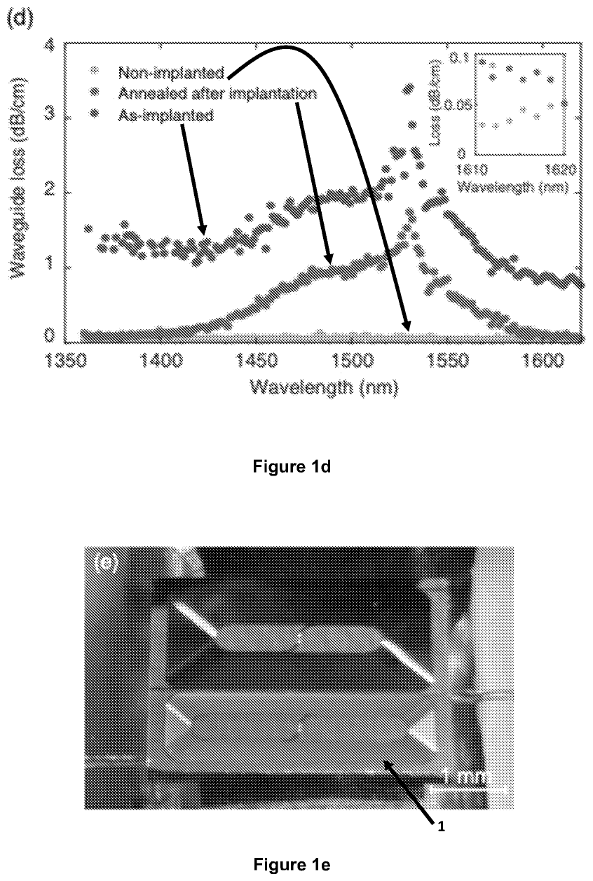

FIGS. 1A, 1B, 1C, 1E, 5A, 5C, 17A to 17C and 19A to 19D show an exemplary amplifier or waveguide amplifier or photonic integrated circuit waveguide amplifier 1 according to the present disclosure. The photonic integrated circuit waveguide amplifier 1 is, for example, an integrated photonic integrated circuit component or element.

The photonic integrated circuit waveguide amplifier 1 comprises at least one cladding material or layer 3 (or embedding cladding material or layer 3), and at least one rare-earth ion implanted waveguide core material or layer 5, for example, silicon nitride (Si₃N₄) material or layer 5 embedded or enclosed in the cladding material or layer 3.

The implanted rare-earth ions or atoms 7 may, for example, consist of or comprise Erbium, Ytterbium, or Thulium. The implanted rare-earth ions 7 may, for example, comprise at least one of: Erbium, Ytterbium, Thulium. Implanting different rare-earth ions permits to provide gain at other wavelengths. Implanted rare-earth ions 7 such as ytterbium (emission at 1.1 μm) and thulium (0.8 μm, 1.45 μm and 2.0 μm) permit to provide optical gain in these other wavelength regions.

The implanted rare-earth ions 7 may, for example, comprise or consist of (i) Erbium and Ytterbium, or (ii) Erbium and Thulium, or (iii) Erbium, Ytterbium and Thulium. Co-doping with other rare-earth ions permit to providing gain (amplification) in multiple wavelength regions in the same amplifier.

The implanted rare earth ions are, for example, located at least at mid-distance inside the at least one rare-earth ion implanted silicon nitride material or layer 5. The rare-earth ion implanted silicon nitride material or layer is configured or dimensioned to support, for example, a fundamental transverse electric TE optical waveguide mode in a cross-sectional direction of the waveguide amplifier 1. The implanted rare earth ions are, for example, located in the rare-earth ion implanted silicon nitride material or layer 5 to spatially overlap with the fundamental transverse electric optical waveguide mode to assure a high optical gain or amplification. The spatial overlap is, for example, at least 25%, or at least 40%, or at least 50%, or at least 60%. At least 85%, or at least 90%, or at least 95% of the implanted rare earth ions are located in the rare-earth ion implanted silicon nitride material or layer 5 to interact with the light of the waveguide mode and be optically active in amplification of the guided light.

The rare-earth ion implanted concentration in the rare-earth ion implanted silicon nitride material or layer 5 is, for example, between 0.1×10²⁰ cm⁻³ and 3.5×10²⁰ cm⁻³. The rare-earth ion implanted silicon nitride material or layer 5 hosts, for example, between 0.1 and 0.3 atom % of rare-earth atoms.

The rare-earth ion implanted silicon nitride material or layer 5 defines or is an active material or active layer of the waveguide amplifier 1. The rare-earth ion implanted silicon nitride material or layer 5 defines or is, for example, an optical gain medium of the waveguide amplifier 1.

The rare-earth ion implanted silicon nitride material or layer 5 defines a non-passive waveguide region or section of the waveguide amplifier 1. The embedding cladding material or layer 3 may define an optically passive waveguide region or section of the waveguide amplifier 1.

The rare-earth ion implanted silicon nitride material or layer 5 defines a waveguide core WC of the waveguide amplifier 1. The waveguide core WC is enclosed or embedded in the cladding material or layer 3. The cladding material or layer 3 hosts the rare-earth ion implanted silicon nitride material or layer 5. The cladding material or layer 3 defines a support or container CS inside which the rare-earth ion implanted silicon nitride material or layer 5 is supported and/or held. The waveguide core WC is configured to propagate amplified light in the elongated (light) propagation direction PD of the waveguide amplifier 1.

The waveguide core WC and the host cladding material or layer 3 have refractive index values or a refractive index contrast permitting the waveguide core WC to guide and propagate light along the waveguide 1 in a light propagation (or guiding) direction PD or elongated propagation direction PD. The waveguide core WC has, for example, a refractive index (at the wavelength of light to be guided) that is greater that the refractive index (at the wavelength of light to be guided) of the cladding material or layer 3. This is also true for the material or medium located or superposed opposite the cladding material or layer 3, for example, that encloses or sandwiches the waveguide core WC with the cladding material or layer 3. This medium may, for example, be the surrounding air or a further cladding material or layer.

The waveguide amplifier 1 may include at least one (further) cladding/passivation material or layer FC superposed on the embedded rare-earth ion implanted silicon nitride material or layer 5 and the embedding cladding material or layer 3.

The cladding material or layer FC may, for example, be provided or deposited on the embedded rare-earth ion implanted silicon nitride material or layer 5 after ion implantation. Alternatively, the at least one cladding material or layer FC may, for example, be provided or deposited on the embedded silicon nitride material or layer 5A prior to rare-earth ion implantation and, in such a case, ion implantation of the silicon nitride material or layer 5A is carried out by passing the ions through the covering cladding material or layer FC.

At least one further cladding/passivation material or layer may, for example, be provided or deposited on the covering cladding material or layer FC after rare-earth ion implantation of the embedded silicon nitride material or layer 5A.

The further cladding material or layer and/or the at least one embedding cladding material or layer are, for example, optically passive elements or components of the waveguide amplifier 1.

The further cladding/passivation material or layer and/or the embedding cladding material or layer may, for example, comprise or consist of silicon dioxide (SiO₂).

The embedding cladding material or layer 3 defines or comprises, for example, first and second lateral supporting structures or platforms SP defining or comprising respectively lateral side walls SW1B, SW2B. The first and second lateral supporting structures SP are in contact with an upper half and/or a lower half of the embedded silicon nitride waveguide core WC or the embedded silicon nitride material or layer, for example, an upper and lower half of lateral side walls SW1A, SW2A of the embedded silicon nitride or waveguide core WC.

The first and second supporting structures SP extend laterally or in a planar direction away from (the upper half and the lower half of) the embedded silicon nitride waveguide core WC. The first and second supporting structures SP extend, for example, a distance LD therefrom that is greater than 0.1 or 0.25 times a cross-sectional width W (0.1×W or 0.25×W) of the embedded silicon nitride waveguide core WC. This can assure a higher optical quality waveguide and reduced optical loss. The cross-sectional width W is, for example, measured at a maximum value in the cross-sectional direction perpendicular to the light propagation direction PD.

The cladding material or layer 3 defines or includes an elongated recess or depression 9 extending in an elongated manner in the cladding material or layer 3. The elongated recess or depression 9 extends, for example, in a planar manner or in the plane of the cladding material or layer 3.

The elongated recess or depression 9 extends in the light propagation direction PD, and the rare-earth ion implanted silicon nitride material or layer 5 is located inside or embedded in the elongated recess or depression 9. The rare-earth ion implanted silicon nitride material or layer 5 fills or fully fills the elongated recess or depression 9. The rare-earth ion implanted silicon nitride (Si₃N₄) material or layer 5 also extends longitudinally along the light propagation direction PD.

The rare-earth ion implanted silicon nitride material or layer 5 and the recess or depression 9 extend in the elongated direction PD to propagate or guide light along the elongated direction PD of the waveguide amplifier 1.

The cladding material or layer 3 may, for example, comprise or consist of a planar layer or material defining or including an elongated recess or depression 9.

The rare-earth ion implanted silicon nitride (Si₃N₄) material or layer 5 and waveguide core WC may also, for example, define a planer layer or material embedded or contained inside the cladding material or layer 3. The rare-earth ion implanted silicon nitride material or layer 5 may, for example, define a substantially planar optical waveguide core WC.

The recess or depression 9 and/or waveguide core WC of the waveguide amplifier 1 of the present disclosure may have a cross-section shape or profile whose width W (measured at maximum value) is greater that its height H (measured at maximum value). For example, the width W is between 1.5 and 5 times greater than the height H, or between 2.5 and 5 times greater than the height H. For example, waveguide core WC may have a width (measured at maximum value) of 2.1 μm (outer cross-sectional width Wₒ) and a height H or thickness (measured at maximum value) of 0.7 μm.

The rare-earth ion implanted silicon nitride material or layer 5 may, for example, define a bowed or curved forward structure, bowed or curved away from the host cladding material or layer 3.

The rare-earth ion implanted silicon nitride material or layer 5 includes an outer or upper/top silicon nitride surface S1 that, for example, is non-directly contacting the embedding cladding material or layer 3 or not covered by the embedding cladding material or layer 3. The rare-earth ion implanted silicon nitride material or layer 5 also includes an inner or lower/bottom surface S3 (defined by a base BS) that is located opposite the outer or upper surface S1.

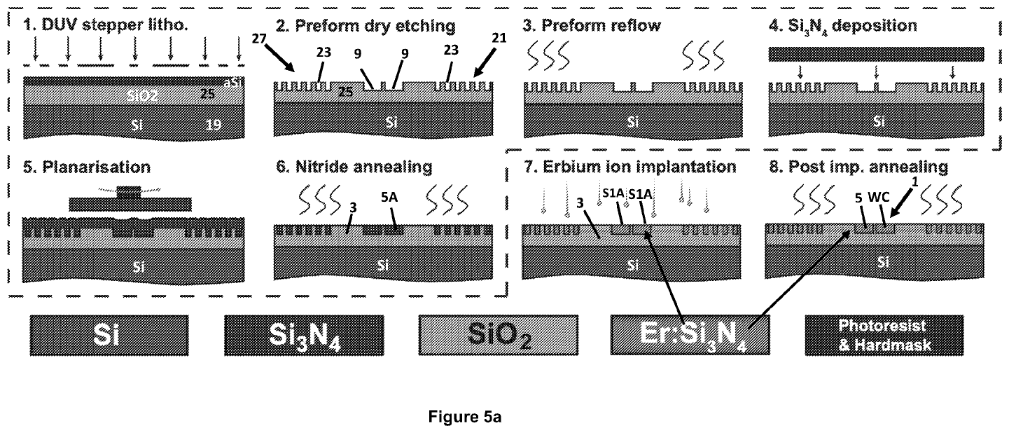

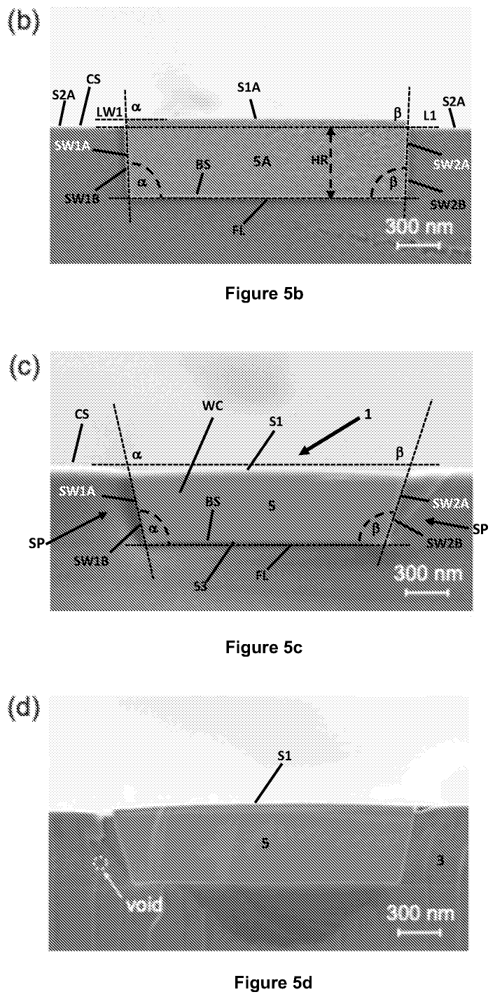

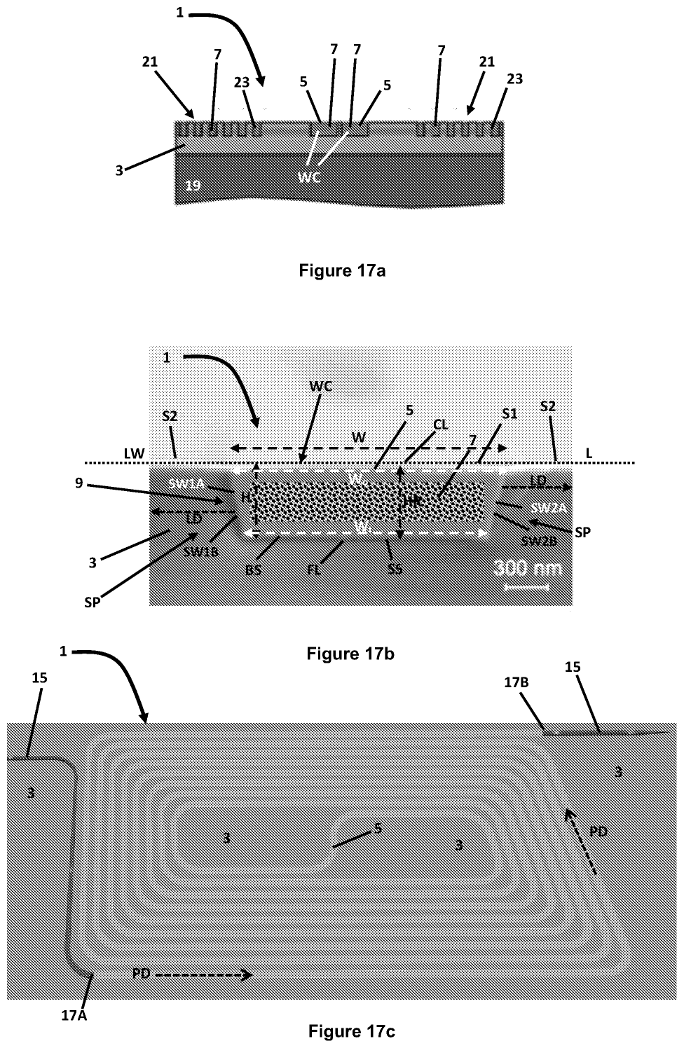

The terms upper/top and lower/bottom are defined relative to the position of the device shown in FIGS. 5b to 5d and 17a to 17b.

The outer direction or location is one extending away from a supporting layer or substrate 19 supporting the embedding cladding material or layer 3 and the embedded (rare-earth ion implanted) silicon nitride material or layer 5, 5A and extending in a direction towards the embedding cladding material or layer 3 and/or the embedded (rare-earth ion implanted) silicon nitride material or layer 5, 5A.

As mentioned, the outer or upper surface S1 may, for example, be directly exposed or uncovered (material-free). Alternatively, as previously mentioned, at least one (further) cladding/passivation material or layer FC may be superposed or provided on the embedded rare-earth ion implanted silicon nitride material or layer 5 (and the outer surface S1) as well as the embedding cladding material or layer 3.

The outer or upper surface S1 is, for example, bowed or protrudes outwards away from the cladding material or layer 3. The embedding cladding material or layer 3 is, for example, absent from the outer surface S1, or the outer surface S1 is embedding cladding material-free.

The bowing or curving is in a direction perpendicular to the elongated propagation direction PD of the waveguide amplifier 1.

The rare-earth ion implanted silicon nitride material or layer 5 may, for example, define an inwardly tapered cross-sectional structure or profile in a cross-sectional direction perpendicular to the elongated propagation direction PD, tapering to reduced width or dimensions in an inward direction towards a bottom of the recess or depression 9. The rare-earth ion implanted silicon nitride material or layer 5 defines an inwardly tapered cross-sectional structure extending from the outer surface S1 and inside the cladding material or layer 3 and in a cross-sectional direction perpendicular to a light elongated propagation direction PD. Tapering occurs from the outer surface S1 a width of the rare-earth ion implanted silicon nitride material or layer 5 is reduced in a direction extending from the outer surface S1 and inside the cladding material or layer 3. The tapered cross-sectional structure is, for example, tapered cross-sectionally along an entire length of the waveguide amplifier 1 that extends in the elongated propagation direction PD.

The rare-earth ion implanted silicon nitride material or layer 5 defines or has, for example, an inner cross-sectional width W_{I} and an outer cross-sectional width Wₒ, where the inner cross-sectional width W_{I} is shorter than the outer cross-sectional width Wₒ. The inner cross-sectional width W_{I} is, for example, measured in a lower half of the rare-earth ion implanted silicon nitride material or layer 5, and the outer cross-sectional width Wₒ is, for example, measured in an upper half of the rare-earth ion implanted silicon nitride material or layer 5. Alternatively, the inner cross-sectional width W_{I} is, for example, the shortest measured cross-sectional width of the rare-earth ion implanted silicon nitride material or layer 5, and the outer cross-sectional width Wₒ is, for example, the largest measured cross-sectional width of the rare-earth ion implanted silicon nitride material or layer 5.

The inner cross-sectional width W_{I} is between 2.5% and 20% shorter than the outer cross-sectional width Wₒ, or between 5% and 15% shorter than the outer cross-sectional width Wₒ, or between 5% and 10% shorter than the outer cross-sectional width Wₒ.

The width ratio expressed as a fraction Wₒ/W_{I} of the embedded rare-earth ion implanted silicon nitride material or layer 5 is greater than the width ratio expressed as a fraction Wₒ/W_{I} of the embedded non-ion implanted silicon nitride material or layer 5A (absence of rare earth ions), as can be seen for example by comparing FIGS. 5B and 5C. The presence of the implanted ions brings this structural difference.

The rare-earth ion implanted silicon nitride material or layer 5 defines or includes outwardly diverging lateral side walls SW1A, SW2A and the embedding cladding material or layer 3 also defines or includes outwardly diverging lateral side walls SW1B, SW2B. The outward direction being that extending towards the outer surrounding air medium or that extending towards a further cladding material or layer 3 (if present) superposed on the rare-earth ion implanted silicon nitride material or layer 5 and/or the embedding cladding material or layer 3.

The outwardly diverging lateral side walls SW1B, SW2B of the embedding cladding material or layer 3 mechanically support, for example, the outwardly diverging lateral side walls SW1A, SW2A of the rare-earth ion implanted silicon nitride material or layer 5.

The outwardly diverging lateral side walls SW1B, SW2B of the cladding material or layer 3 simultaneously diverge with and/or contact directly, for example, the outwardly diverging lateral side walls SW1A, SW2A of the rare-earth ion implanted silicon nitride material or layer 5.

The first lateral side wall SW1A, and the second lateral side wall SW2A of the rare-earth ion implanted silicon nitride material or layer 5 define respectively inclination angles α, β with respect to a floor FL of the cladding material or layer 3 defining a floor of the recess 9, or alternatively angles α, β with respect to a surface or outer surface CS of the embedding cladding material or layer 3. The inclination angles α, β are greater than or equal to 95°. The inclination angles α, β are greater than or equal to a value x that is 91°, or 92°, or 93° or 94° or 95°, and less than or equal to a value y that is 100°, or 101°, or 102°, or 103° or 104° or 105°; where inclination angles α, β are greater than or equal to the value x and less than or equal to the value y.

The angle α and/or the angle β of the lateral side walls SW1A, SW2A of the embedded rare-earth ion implanted silicon nitride material or layer 5 are greater than angle α and/or the angle β of the lateral side walls SW1A, SW2A of the embedded non-ion implanted silicon nitride material or layer 5A (absence of rare earth ions), as can be seen for example by comparing FIGS. 5B and 5C. The presence of the implanted ions brings this structural difference.

The rare-earth ion implanted silicon nitride material or layer 5 may define or include a ceiling or landing CL. The ceiling or landing CL extends between the lateral side walls SW1A, SW2A of the embedded ion implanted silicon nitride material or layer 5. The ceiling CL is, for example, a curved ceiling or curved upper-level CL. The curved ceiling or upper-level CL curves or bends outwards to define a surface extending away from the embedding cladding material or layer 3, or extending out of the recess or depression 9 or a direction out of the recess or depression 9. The curved ceiling or upper-level CL is bulging or convex out from or out of the recess or depression 9.

The above-described cross-sectional profile of the rare-earth ion implanted silicon nitride material or layer 5 and the embedding cladding material or layer 3 extend elongated or along the length of the waveguide amplifier and results from the implantation of the rare earth ions inside the silicon nitride material or layer 5 and waveguide core WC, where implantation is carried out directly through the directly exposed or uncovered (at least at the moment of ion implantation) outer surface S1 of the silicon nitride material or layer 5. A similar profile can be expected in the case implantation is carried out through a covered outer surface S1, for example, covered by cladding layer or material FC (FIG. 18).

The floor FL and the lateral side walls SW1B, SW2B of the cladding material or layer 3 define the recess or depression 9 of the cladding material or layer 3 in which the waveguide core WC is embedded. The upper-level or ceiling CL of the silicon nitride material or layer is not covered or in direct contact with the embedding cladding material or layer 3. In addition to the lateral sides walls, a base BS of the silicon nitride material or layer 5A or waveguide core WC is in (direct) contact with the floor FL of the cladding material or layer 3 prior to ion implantation and remains in (direct) contact after rare-earth ion implantation.

The floor FL and the lateral side walls SW1B, SW2B of the cladding material or layer 3 contact and contain the silicon nitride material or layer 5A (waveguide core WC) inside the recess or depression 9. The base BS is fully contained inside the recess 9 and the lateral side walls SW1A, SW2A of the silicon nitride material or layer 5A are contained inside the recess 9. For example, at least 75% or at least 85% of the height H of the lateral side walls SW1A, SW2A of the waveguide core material or layer 5A is contained inside the recess 9. This confinement allows to control or restrict deformation of the silicon nitride material or layer (waveguide core WC) resulting from ion implantation and assures that a rare earth ion implanted waveguide core material or layer 5 can be obtained having a cross-sectional profile permitting efficient guiding, sufficiently low optical loss and efficient light amplification.

The embedded silicon nitride waveguide core WC fills a recess or depression 9 of the embedding cladding material or layer 3 to define the outer surface S1 that is, for example, located (substantially) at a same level L as that of an outer surface S2 defined by the embedding cladding material or layer 3 (see for example FIG. 17b).

The floor FL of the embedding cladding material or layer 3 comprises or defines a support surface SS (FIG. 17b). The embedded silicon nitride waveguide core WC extends inside the embedding cladding material or layer 3 away from the support surface SS to define the outer or upper silicon nitride surface S1 substantially at a same level as that of the outer or upper surface S2 defined by the embedding cladding material or layer 3.

The recess or depression 9 defined by the embedding cladding material or layer 3 has, for example, a recess height HR (FIG. 17b) in a direction perpendicular to the light propagation direction of the waveguide. The embedded silicon nitride waveguide core WC fills the recess or depression 9 to define the outer surface S1 of the waveguide core WC that is located at a height level LW. The height level LW has, for example, a value between 0.8 and 1.1 times (or between 0.75 and 1.2 times) the recess height value HR. For example, the outer surface S1 may be perfectly level with the outer surface S2 defined by the embedding cladding material or layer 3, in such a case the height level LW has a value 1× times the recess height value HR, that is the same height as the recess height HR. The height values are measured from the floor FL of the recess or depression 9 defined by the embedding cladding material or layer 3.

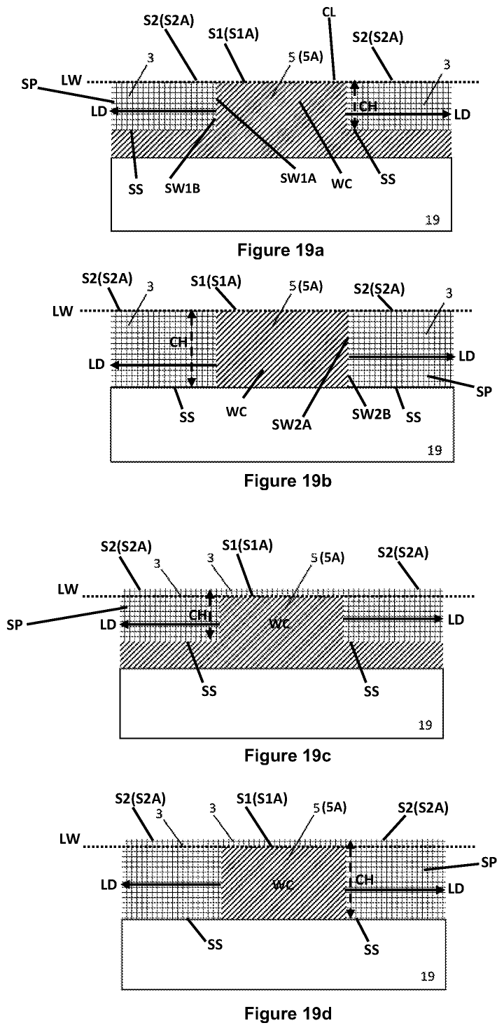

FIGS. 19a to 19d schematically show alternative embodiments of the photonic integrated circuit waveguide amplifier 1 fabricated by removing and structuring the silicon nitride material or layer 5A provided, for example, on at least one support material or layer 19. At least one cladding material or layer 3 is provided or deposited on the silicon nitride material or layer 5A, and if necessary removed or thinned back to directly expose the silicon nitride material or layer 5A to be implanted, or thinned back or removed to leave a cladding layer or material thickness covering the silicon nitride material or layer 5A that can be traversed by the ions to assure ion implantation in the silicon nitride material or layer 5A. Ion implantation of the silicon nitride material or layer 5A is then carrying out, as is detailed further below.

In this embodiment (FIGS. 19a to 19d), the embedded silicon nitride waveguide core WC extends inside the embedding cladding material or layer 3, and away from a support surface SS defined by the silicon nitride material or layer or by the support material or layer 19, to define the outer or upper silicon nitride surface S1 substantially at a same level as that of an outer or upper surface S2 defined by the embedding cladding material or layer 3. The lateral side walls SW1A, SW2A of the rare-earth ion implanted silicon nitride material or layer 5 extend upwards or in an outer direction to define the ceiling or landing CL extending between the lateral side walls SW1A, SW2A, the ceiling or landing CL comprises or defines the outer or upper silicon nitride surface S1.

The embedding cladding material or layer 3 extends away from a support surface SS to define an outer or upper cladding surface S2 located at a cladding height CH (extending cross-sectionally perpendicular to the light propagation direction) from the support surface SS. The embedded silicon nitride waveguide core WC extends, for example, inside the embedding cladding material or layer 3 and away from the support surface SS to define the outer or upper silicon nitride surface S1 located at a height level LW that has a value between 0.01 and 1.0 times the cladding height CH, or between 0.1 and 1.0 times the cladding height CH, or between 0.5 and 1.0 times the cladding height CH. The height values are measured from the support surface SS.

FIGS. 19a to 19d also schematically show the non-ion implanted silicon nitride material or layer 5A. The ion-implanted silicon nitride material or layer 5 assures, for example, the same characteristics or properties as those described herein in relation to the ion-implanted silicon nitride material or layer 5 located in the depression 9 of the embedding cladding material or layer 3.

The waveguide amplifier or device 1 may also include at least one or a plurality of passive or non-amplification components 15 (see, for example, FIG. 17C). The passive or non-amplification component 15 is, for example, identical to the waveguide amplifier 1 except that it includes an embedded non-ion implanted silicon nitride material or layer 5A (absence of rare earth ions), as can be seen for example in FIG. 5B. The passive or non-amplification component 15 may be integrally connected with the embedded rare-earth ion implanted silicon nitride material or layer 5. The embedded non-ion implanted silicon nitride material or layer 5A may be continually connected or integrated with the embedded rare-earth ion implanted silicon nitride material or layer 5. The cladding material or layer 3 of the passive or non-amplification component 15 may also be continually connected or integrated with the cladding material or layer 3 containing the embedded rare-earth ion implanted silicon nitride material or layer 5. The passive or non-amplification component 15 may be formed using selective ion implantation, as will be discussed later.

As shown in FIG. 1a, light may be coupled into the passive or non-amplification component 15 or the waveguide amplifier or device 1 using one or more integrated couplers or integrated coupling waveguides.

The passive or non-amplification component 15 has, for example, the width ratio expressed as a fraction Wₒ/W_{I} of the embedded non-ion implanted silicon nitride material or layer 5A that is less than that of the embedded rare-earth ion implanted silicon nitride material or layer 5.

Additionally or alternatively, the angle α and/or the angle β of the lateral side walls SW1A, SW2A of the embedded non-ion implanted silicon nitride material or layer 5A of the passive or non-amplification component 15 are less than those of the lateral side walls SW1A, SW2A of the embedded rare-earth ion implanted silicon nitride material or layer 5.

The rare-earth ion implanted silicon nitride material or layer 5 may include a light input coupling interface or port 17A, and/or an amplified light output coupling interface or port 17B. The coupling interface or port may, for example, comprise the ion-implanted and non-ion implanted material interface with a passive or non-amplification component 15, or a facet of the embedded rare-earth ion implanted silicon nitride material or layer 5 and/or cladding material or layer 3, that may be formed, for example, by dicing.

The rare-earth ion implanted silicon nitride material or layer 5 and/or the recess 9 of the embedding cladding material or layer 3 may extend, for example, in an elongated manner along the light propagation direction PD over a distance, for example, between 0.1 m and 0.6 m.

The rare-earth ion implanted silicon nitride material or layer 5 and the recess 9 of the cladding material or layer 3 may (longitudinally) extend in a substantially straight and/or curved manner. They may, for example, extend (longitudinally) along the light propagation direction PD to define a spiral and/or coil arrangement, as for example shown in FIG. 17C.

The cladding material or layer and/or the at least one embedding cladding material or layer are optically passive elements or components of the waveguide amplifier.

The waveguide amplifier 1 may further include a supporting layer or substrate 19 supporting the embedding cladding material or layer 3, and the embedded rare-earth ion implanted silicon nitride material or layer 5. The supporting layer or substrate 19 may for example comprise or consist of silicon, MgF₂ or CaF₂.

The embedding cladding material or layer 3 defines or includes, for example, a stress release recess structure 21 comprising a plurality of indentations or depressions 23 formed in the embedding cladding material or layer 3 (FIG. 17a). The stress release recess structure 21 prevents cracks forming or propagating to or into the waveguide core WC or into the embedded rare-earth ion implanted silicon nitride material or layer 5. The stress release recess structure 21 encloses, for example, the waveguide recesses 9.

A depth of the indentations of the plurality of indentation 23 of the stress release recess structure 21 measured from an outer surface of the cladding material or layer 3 is, for example, substantially equal to or greater than a depth of the at waveguide recess 9 measured from the outer surface of the cladding material or layer 3. the stress release recess structure encloses the at least one waveguide recess.

A recess-free zone may, for example, separate the stress release recess structure 21 and the waveguide recess 9 by a distance D where 50 μm<D<2 μm. The waveguide recess 9 and the stress release recess structure 21 are, for example, located in the same plane of the cladding material or layer 3.

The plurality of indentations 23 are, for example, regularly or irregularly spaced one from the other. The plurality of indentations form, for example, at least one repeating pattern of indentations across the cladding material or layer 3. The plurality of indentations 23 form, for example, a checkerboard structure or layout across the cladding material or layer 3.

The waveguide amplifier 1 is, for example, a photonic circuit integrated waveguide amplifier, or a chip-based (or photonic chip-based) waveguide amplifier. The waveguide amplifier 1 is, for example, a photonic integrated circuit component or a planar lightwave circuit component. The waveguide amplifier 1 is, for example, a planar substrate-based integrated amplifier.

According to another aspect, the present disclosure also concerns a system including a pump laser or source and at least one photonic integrated circuit waveguide amplifier 1.

According to another aspect, the present disclosure also concerns a photonic integrated circuit PIC including at least one photonic integrated circuit waveguide amplifier 1. The photonic integrated circuit PIC may, for example, include one or more integrated silicon nitride component or device optically coupled to the photonic integrated circuit waveguide amplifier 1, or comprising the photonic integrated circuit waveguide amplifier 1. The integrated silicon nitride component or device may, for example, comprise or consist of a soliton microcomb generator, or an electro-optical modulator, or a laser source. The electro-optical modulator may, for example, comprise or consist of a lithium niobate electro-optical modulator.

According to another aspect, the present disclosure further concerns an integrated optical device or integrated laser source including at least one photonic integrated circuit waveguide amplifier 1, where the photonic integrated circuit waveguide amplifier 1 serves as a gain medium of the integrated optical device or integrated laser source. The integrated optical device or integrated laser source may, for example, comprise or consist of a soliton microcomb, a rare-earth CW laser, a femtosecond mode-locked laser or a cavity soliton laser.

According to another aspect, the present disclosure concerns a waveguide amplifier fabrication method or photonic integrated circuit waveguide amplifier fabrication method.

FIG. 5A shows an exemplary photonic integrated circuit waveguide amplifier fabrication method according to the present disclosure where an exemplary Er:Si₃N₄ waveguide amplifier fabrication is shown. The exemplary fabrication process uses a photonic Damascene process generally shown as those steps inside dashed line box of FIG. 5A. Details of the Damascene process are disclosed in US patent U.S. Pat. No. 10,191,215, the entire contents of which are incorporated herein by reference. The fabrication process further comprises ion implantation and ion activation.

The waveguide amplifier fabrication method comprises providing the at least one embedding cladding material or layer 3 comprising the at least one silicon nitride material or layer 5A embedded or buried inside the at least one embedding cladding material or layer 3, and carrying out rare-earth ion implantation by ion irradiation of the at least one outer or upper silicon nitride surface S1A of the at least one embedded or buried silicon nitride material or layer 5A to form at least one rare-earth ion implanted silicon nitride material or layer 5 embedded or buried in the at least one embedding cladding material or layer 3.

The rare-earth ion implantation is, for example, carried out by ion irradiation of the directly exposed or uncovered surface(s) S1A of the embedded or buried silicon nitride material or layer 5A (see for example FIG. 5a) to form the rare-earth ion implanted silicon nitride material or layer 5 embedded or buried in the at least one embedding cladding material or layer 3.

As previously mentioned, the floor FL and the lateral side walls SW1B, SW2B of the cladding material or layer 3 contact and contain the silicon nitride material or layer 5A (waveguide core WC) inside the recess or depression 9. This confinement allows to control or restrict deformation of the silicon nitride material or layer (waveguide core WC) resulting from ion implantation and permits a rare earth ion implanted waveguide core material or layer 5 to be obtained having a cross-sectional profile assuring efficient guiding, sufficiently low optical loss and efficient light amplification.

The embedded silicon nitride waveguide material 5A fills the recess or depression 9 of the embedding cladding material or layer 3 to define the outer surface S1A that is, for example, located at a same level or substantially the same level LI as that of an outer surface S2A defined by the embedding cladding material or layer 3 (see for example FIG. 5b).

The recess or depression 9 defined by the embedding cladding material or layer 3 has, for example, a recess height HR (FIG. 5b) in a direction perpendicular to the light propagation direction of the waveguide. The embedded silicon nitride waveguide core WC fills the recess or depression 9 to define the outer surface S1A of the waveguide core WC that is located at a height level LW1. The height level LW1 has, for example, a value between 0.8 and 1.1 times (or 0.75 and 1.2 times) the recess height value HR. For example, the outer surface S1A may be perfectly level with the outer surface S2A defined by the embedding cladding material or layer 3, in such a case the height level LW1 has a value 1× times the recess height value HR, that is the same height as the recess height HR. The height values are measured from the floor FL of the recess or depression 9 defined by the embedding cladding material or layer 3.

FIG. 5a shows, for example, two embedded silicon nitride material or layers 5A that are simultaneously ion implanted. A second recess 9 is included in the embedding cladding material or layer 3 in which the second embedded silicon nitride material or layer 5A is present. This second waveguide core may, for example, be an independent element or may, for example, be for inputting electromagnetic energy to the first waveguide core and receiving electromagnetic energy outputted therefrom. This second waveguide core may alternatively be non-ion implanted.

The stress release recess structure 21 comprising the plurality of indentations or depressions 23 encloses the at least one or both recesses or depressions 9 and silicon nitride waveguide core WC. The plurality of embedded silicon nitride material or layers 5A can be ion implanted simultaneously, or only one of embedded silicon nitride material or layers 5A is ion implanted.

Annealing of the at least one rare-earth ion implanted silicon nitride material or layer 5 embedded or buried in the at least one embedding cladding material or layer 3 is carried out to reduce implantation defect optical losses. Annealing is carried out at a temperature between 800° and 1250° C., for example, at 1000° C. Annealing is, for example, carried out at in an oxygen environment. Annealing is carried out, for example, for a duration between 30 and 90 minutes, for example 60 minutes.

While FIG. 5a illustrates erbium implantation, the rare-earth ions may comprise or consist of Erbium, Ytterbium, or Thulium. The rare-earth ion implantation is carried out by accelerating rare-earth ions towards the at least one directly exposed surface S1A to provide an ion implantation fluence to the at least one directly exposed surface S1A for ion implantation inside the at least one embedded or buried silicon nitride material or layer 5A.

Implantation can be carried out using, for example, a Van der Graaf accelerator. The ion implantation process is described in the article by Polmann et al and reference 124 mention in the reference section below, the entire contents of which are incorporated herein by reference.

The rare-earth ion implantation is, for example, carried out at a plurality of different rare-earth ion acceleration values to define an ion implantation concentration spatial profile spatially overlapping with an optical waveguide mode of the waveguide amplifier, for example, a fundamental transverse electric optical waveguide mode.

The rare-earth ion implantation is carried out, for example, at rare-earth ion acceleration values between 0.1 MeV and 2.5 MeV. The rare-earth ion implantation is, for example, carried out at a rare-earth ion acceleration value assuring a rare-earth ion fluence between 1.5×10¹⁵ cm⁻² and 5×10¹⁵ cm⁻². The rare-earth ion implantation is carried out, for example, to provide a rare-earth ion implanted concentration in the at least one rare-earth ion implanted silicon nitride material or layer 5 between 0.1×10²⁰ cm⁻³ and 3.5×10²⁰ cm⁻³. The rare-earth ion implantation is carried out, for example, to provide at least one rare-earth ion implanted silicon nitride material or layer hosting between 0.1 and 0.3 atom % of rare-earth atoms. The rare-earth ion implantation can be carried out as a wafer scale implantation process.

At least one cladding/passivation material or layer can be provided or deposited superposed on the embedded rare-earth ion implanted silicon nitride material or layer 5 and the embedding cladding material or layer 3 after rare-earth ion implantation.

Alternatively, rare-earth ion implantation of the embedded or buried silicon nitride material or layer 5A can be carried out by ion irradiation through at least one cladding material or layer FC provided or deposited on the at least one surface S1A of the embedded or buried silicon nitride material or layer 5A to form the rare-earth ion implanted silicon nitride material or layer 5 embedded or buried in the embedding cladding material or layer 3 (see, for example, FIG. 18).

The cladding material or layer of the device 1 covering the upper or outer surface of the waveguide core WC may be ion-implanted, or may be non-ion implanted. The ions may be accelerated fully through the covering material to be penetrate deep inside the waveguide material and not the cladding material.

The cladding material or layer FC can be, for example, provided or deposited directly on (the surface(s) thereof S1A) the embedded or buried silicon nitride material or layer 5A. The cladding material or layer FC may, for example, have a thickness of between 1 nm and 500 nm, for example, 200 nm. Such deposition may be carried out prior to the ion implantation step shown in FIG. 5a, for example, after the nitride annealing step.

An additional cladding material or layer may optionally be deposited on the cladding material or layer FC after ion implantation.

The step of providing the at least one embedding cladding material or layer 3 comprising the at least one silicon nitride material or layer 5A embedded, buried or enclosed inside the at least one embedding cladding material or layer 3 may alternatively involve providing structures fabricated by a subtractive approach removing and structuring the silicon nitride material or layer 5A provided, for example, on at least one support material or layer 19. Such exemplary structures are shown in FIGS. 19A to 19D.

As mentioned above, at least one cladding material or layer 3 is provided or deposited on the silicon nitride material or layer 5A, and if necessary removed or thinned back to directly expose the silicon nitride material or layer 5A to be implanted, or thinned back or removed to leave a cladding layer or material thickness covering the silicon nitride material or layer 5A that can be traversed by the ions to assure ion implantation in the silicon nitride material or layer 5A. Ion implantation of the silicon nitride material or layer 5A is then carrying out.

That is, in this subtractive process, one defines at least one the waveguide core WC by lithography and vertical etching of a blanket silicon nitride film, one deposits an (oxide) cladding layer to cover the waveguide core WC and create the lateral supports SP of the waveguide core WC, and for example, polish down the cladding layer to create a (flat) top surface. In the polishing, one either stops on the waveguide core top surface (FIG. 19a, 19b) or before reaching this top surface (FIGS. 19c, 19d). If the removal stops before the waveguide core top surface, it results in a remaining cladding material or layer on the top of waveguide core WC that is penetrated therethrough during the ion implantation of the waveguide core WC or silicon nitride material.

Selective masking may be carried out during rare-earth ion implantation to form (i) at least one first portion comprising at least one rare-earth ion implanted silicon nitride material or layer 5 embedded or buried in the at least one embedding cladding material or layer 3, and (ii) at least one second portion comprising at least one non-implanted silicon nitride material or layer 5A embedded or buried in the at least one embedding cladding material or layer 3. The silicon nitride material or layer 5 embedded or buried in the embedding cladding material or layer 3 of the first portion is, for example, optically coupled to the silicon nitride material or layer 5A embedded or buried in the embedding cladding material or layer 5A of the second portion.

Prior to carrying out rare-earth ion implantation, annealing is for example carried out to remove Hydrogen from the embedding cladding material or layer 3, and/or the at least one silicon nitride material or layer 5A embedded in the embedding cladding material or layer 3.

The step of providing the at least one embedding cladding material or layer 3 comprising at least one silicon nitride material or layer 5A embedded or buried inside the at least one embedding cladding material or layer 3 comprises, for example, providing a cladding material or layer 25 for embedding one or more waveguide cores WC and including one or more waveguide recesses or depressions 9 and the stress release recess structure 21 for receiving silicon nitride waveguide material, and depositing the silicon nitride waveguide material onto the cladding material or layer 25 and into both the waveguide recess 9 and the stress release recess structure 21 (the indentations 23 thereof). The silicon nitride waveguide material fully or excessively fills the depression 9 and the indentation of the stress release recess structure 21.

The excess material is planarized. a planarization of the deposited silicon nitride waveguide material is carried out. Planarization of the deposited silicon nitride waveguide material is carried out, for example, using mechanical planarization and chemical planarization.

Thermal energy is, for example, applied to the cladding material or layer 25 before deposition of the silicon nitride waveguide material to permit reflow of an exposed surface of the at least one waveguide recess 9 to lower optical losses of the waveguide. The thermal energy is applied, for example, by placing the device in a furnace or oven or by application of laser energy to the exposed surface of the waveguide recess 9.

A hard mask layer including at least one waveguide recess 9 and a stress release recess structure is used to form the at least one waveguide recess 9 and the stress release recess structure 21 in the cladding material or layer 25 for embedding the waveguide core WC and using the hard mask layer and a dry plasma etch and/or a wet etch. The hard mask layer comprises, for example, amorphous silicon (aSi).

The cladding material or layer 25 for embedding the waveguide core WC, the embedding cladding material or layer 3 and/or cladding material or layer FC provided or deposited on the embedded or buried silicon nitride material or layer 5A may, for example, comprise or consist of silicon dioxide (SiO₂).

While silicon dioxide has been mentioned herein as one possible example of the cladding material or layer, alternatively, the cladding material or layer may comprise or consist of oxide materials such as TeO₂ or Al₂O₃, or one or more polymers.

As mentioned, the waveguide core material or layer 5, 5A may comprise of consist of silicon nitride Si₃N₄, SiNₓ; alternatively, the waveguide core material or layer 5, 5A may comprise of consist of Tantala (TaO₅, tantalum penoxide), SiC, Hydex or Litium Niobate LNOI.

In an exemplary fabrication method shown in FIG. 5a, the fabrication process of the rare earth ion (erbium)-implanted silicon nitride Si₃N₄ PICs [121-123] starts with the provision of a (commercial 4-inch) silicon wafer with, for example, a 4-micron thick wet thermal oxide 25.

A stack of silicon oxide and silicon nitride thin films, or alternatively a layer of amorphous silicon aSi are deposited by low-pressure chemical vapor deposition (LPCVD) to serve as the hard-mask.

The waveguide structure and filler pattern for stress release are then defined by, for example, deep ultra-violet photolithography (ASML PAS 5500/350C stepper, JSR M108Y resist, and Brewer DUV-42P coating) and transferred into the thermal oxide layer by multiple steps of fluorine chemistry based reactive ion etching (RIE).

Thus, a preform 27 with recesses 9 for the waveguides and filler pattern 21 is created.

In the case of a wafer using amorphous silicon aSi as a hard-mask, the remaining hard-mask material is stripped in concentrated KOH solution at, for example, 60° C.

A thermal treatment at, for example, 1250° C. is then applied to reflow the silicon oxide, reducing the roughness caused by the RIE etching [122], before the preform recesses 12 and indentations 23 are filled with stoichiometric Si₃N₄ by LPCVD.

Immediately after the deposition, an etchback process comprising photoresist spin-coating and RIE can be performed to roughly planarize the surface and remove most of the excess Si₃N₄ material.

Chemical mechanical polishing (CMP) is then applied to reach the desired waveguide thickness, and create a top surface with sub-nanometer root-mean-square roughness. The wafers are then annealed at 1200° C. to drive out hydrogen, which is known to induce light absorption losses at the technologically relevant wavelengths.

Using this fabrication process, Si₃N₄ waveguides WC are created buried in a wet oxide cladding but with the top surface exposed, allowing for direct erbium implantation into the waveguides WC.

Optionally, the PIC die(s) can be separated by ultraviolet (UV) photolithography, deep RIE, and backside grinding. This die separation process allows to create smooth chip facets which enables high coupling efficiency to optical fibers. This is useful for performing measurements on proof-of-concept devices.

Rare earth ion implantation, for example, erbium ion implantation of the Si₃N, PIC or silicon nitride material or layer 5A is performed. Implantation can be carried out using high-energy ion accelerators, for example, a 2 MV Van der Graaf accelerator from the HVEC company. In this demonstration, the samples were mounted on to a 2-inch silicon backing wafer and mounted perpendicular to the beam. The beam was electrostatically scanned across the wafer to ensure good uniformity, with a scanned beam current of ˜40 nA.

Annealing is carried out to reduce implantation defect caused optical losses. The samples demonstrating high amplification performance were those annealed in, for example, a microelectronic grade furnace at 1000° C. in O₂ under atmosphere pressure for 1 hour.

A passivation layer, for example, of SiO₂ may be optionally applied on top afterwards to enable co-integration of other functional devices such as metal microheaters and piezo actuators.

FIGS. 5(b), (c) and (d) compare scanning electron microscopy (SEM) images of cross sections of reference waveguides on the same wafer before ion implantation, after implantation and annealing (at, for example, 1000° C.), and after implantation and annealing at 1200° C., respectively. Compared to the waveguide before implantation, implanted waveguides shown in FIGS. 5(c) and (d) exhibit a noticeable waveguide geometry deviation, which is considered to be attributed to volume expansion of Si₃N₄ during ion implantation. Despite the apparent distortion of the waveguide cross section, according to the ring resonator measurements and OFDR measurements, the effect on the waveguide background loss is still minimal.

In the search for optimum post-implantation annealing process condition, the pushed the annealing temperature to 1200° C. for the sample shown in FIG. 5(d). Voids are observed with a figure size of 10-30 nm after short time buffered HF treatment at the lateral sides of the Si₃N₄ waveguide rather than underneath the waveguide. Such voids indicate the formation of erbium oxide precipitates, which are soluble in HF, in the SiO₂ cladding after annealing at more than 1000° C. [124]. It has been reported that the erbium ions in such precipitations are inactive for optical amplification and may lead to elevated unsatuable loss [125]. In contrast, FIG. 5(c) shows that the sample annealed at 1000° C. does not feature these voids associated with precipitations, which agrees with the observation in [124]. Interestingly, such voids are not observed in the Si₃N₄ waveguide cores in any sample under inspection. This provides evidence showing that unlike SiO₂, Si₃N₄ can be a good host for the erbium dopant, which can accommodate at least 0.3 at. % of erbium atoms without precipitation problem in the demonstrations of the Inventors. Annealing carried out up to a temperature of 1250° C. produces viable waveguide amplifiers.

The present disclosure also concerns a waveguide amplifier 1 produced according to the waveguide fabrication method described herein, as well as a device including the produced waveguide amplifier 1.

The Inventors have thus overcome the challenges of the prior art and demonstrate a waveguide amplifier and a photonic integrated circuit based erbium-implanted Si₃N₄ (Er:Si₃N₄) amplifier based on meter-scale ultralow-loss Si₃N₄ waveguides.

More specific exemplary details and results provided by the exemplary devices of the present disclosure are now presented, demonstrating the advantage of the device and fabrication method of the present disclosure. A summary is first provided immediately below with more specific details and the determined results being presented further below.

The exemplary integrated Er:Si₃N₄ amplifier achieves an on-chip output power of 145 mW (21.6 dBm) and a small-signal gain of more than 30 dB. This result presents a gain performance on par with commercial EDFAs, a more than 100-fold improvement with respect to existing photonic inte-grated circuit based EDWAs (16-18), and exceeding what has been achieved (17.5 dBm output power) in state-of-the-art heterogeneously integrated III-V amplifiers in silicon-photonics (21) (see below for details), and makes the technology viable for real-world applications.

Exemplary devices are fabricated up to 0.5 meter long densely-packed Si₃N₄ (FIG. 1(b)) spiral waveguides with a cross section of 0.7×2.1 μm² using the photonic damascene process (14), which exhibit ultralow propagation losses of <5 dB/m. The Inventors do not add an upper oxide cladding to the devices before implantation. Next ion implantation (6) is carried out, a wafer-scale process that benefits from much lower cooperative upconversion compared to co-sputtered films (15), to the Si₃N₄ integrated circuits. This endows the Si₃N₄ platform with gain, as schematically shown in FIG. 1(a). Despite adopting a 0.5-m-long Er:Si₃N₄ waveguide, using spiral coil arrangements with a gap spacing of 3 μm achieves a compact footprint of only 1.2×3.6 mm² (FIG. 1(b)). In order to achieve a large overlap of Γ≈50% between the embedded ions with the fundamental optical mode of the waveguide, the Inventors used, for example, three successive implantation steps to the Si₃N₄ waveguide using ion energies of 2.0, 1.416 and 0.966 MeV and corresponding ion fluences of 4.50×10¹⁵, 3.17×10¹⁵ and 2.34×10¹⁵ cm⁻², respectively. FIG. 1(c) shows the simulated concentration profile with a maximum depth of 400 nm in Si₃N₄ using the Monte-Carlo program package ‘Stopping and Range of Ions in Matter’ (SRIM), which matches well with Rutherford backscattering spectrometry (RBS) measurement.

Upon implantation, one observes an increase in waveguide background loss from <5 dB/m to 100 dB/m due to implantation defects, as shown in FIG. 1(d). One observes that the background loss outside the erbium absorption band can be significantly reduced after annealing at, for example, 1000° C. in oxygen for one hour, approaching the same level as undoped waveguides. The loss is extrapolated from intrinsic resonance linewidth measurement of a doped microring resonator. Moreover, one observes upon annealing green luminescence stemming from cooperative upconversion when intensively pumping the devices at 1480 nm (FIG. 1(e)). Notably, such a loss only contributes <2.5 dB background loss for a 0.5-m-long waveguide, significantly lower than the 30 dB passive loss for waveguides of equal lengths in prior work (16,17), which deplete the pump early and prevent efficient amplification.

Moreover, the Inventors investigated selective masking (using photoresist) during ion implantation, which can provide a basis for integrating both passive and active components in Si₃N₄ waveguides, e.g. combining Kerr frequency combs with erbium waveguide amplifiers.

Although waveguide deformations in the implanted regions are observed, the waveguide cross section can be well sustained due to the mechanical support of the lateral oxide cladding (the inset of FIG. 1(c)), thereby minimizing reflections and enabling low-loss transitions from gain regions to passive waveguide regions (FIG. 1(a)). In con-trast, for the same implantation conditions, severe deformations of Si₃N₄ waveguides without cladding are observed, as detailed later.

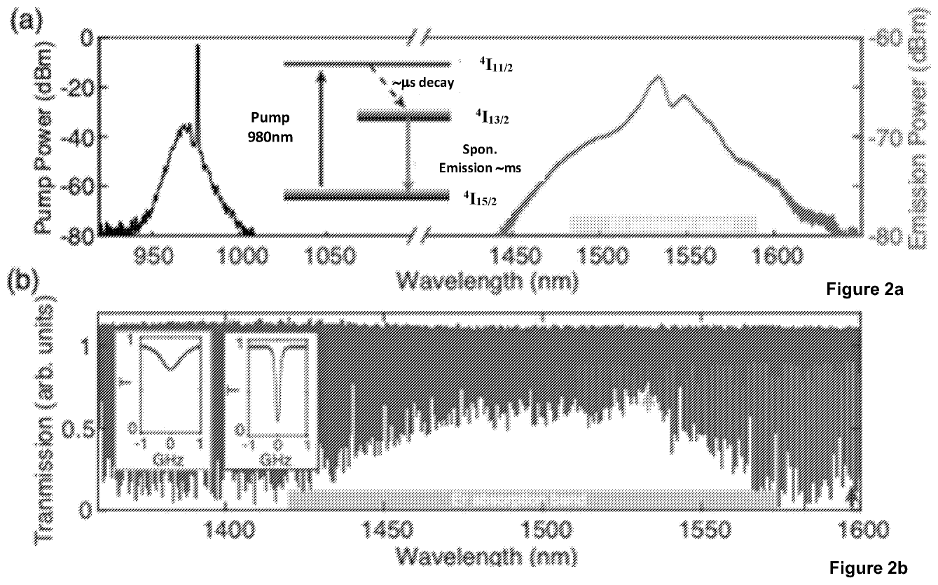

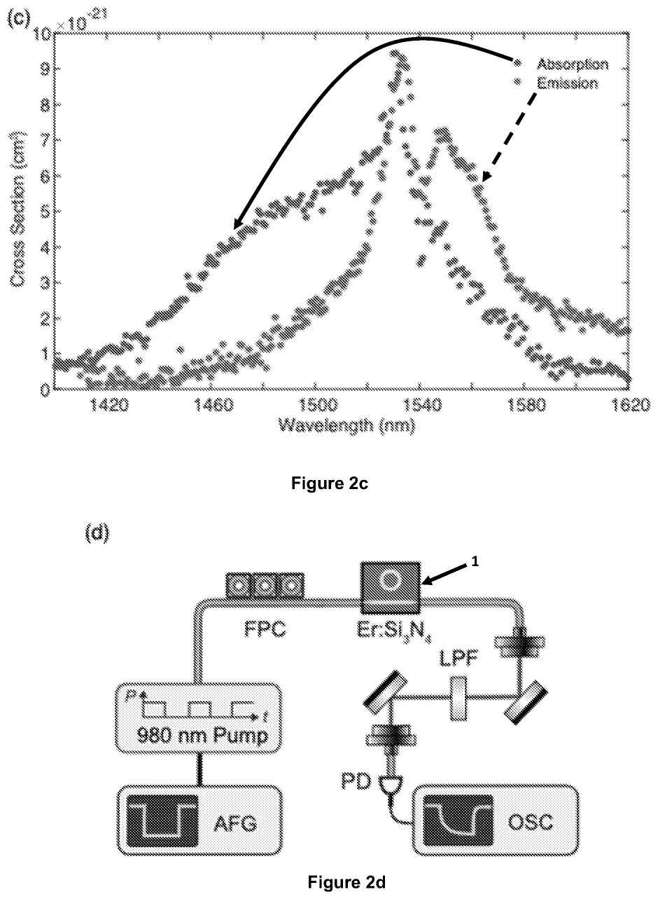

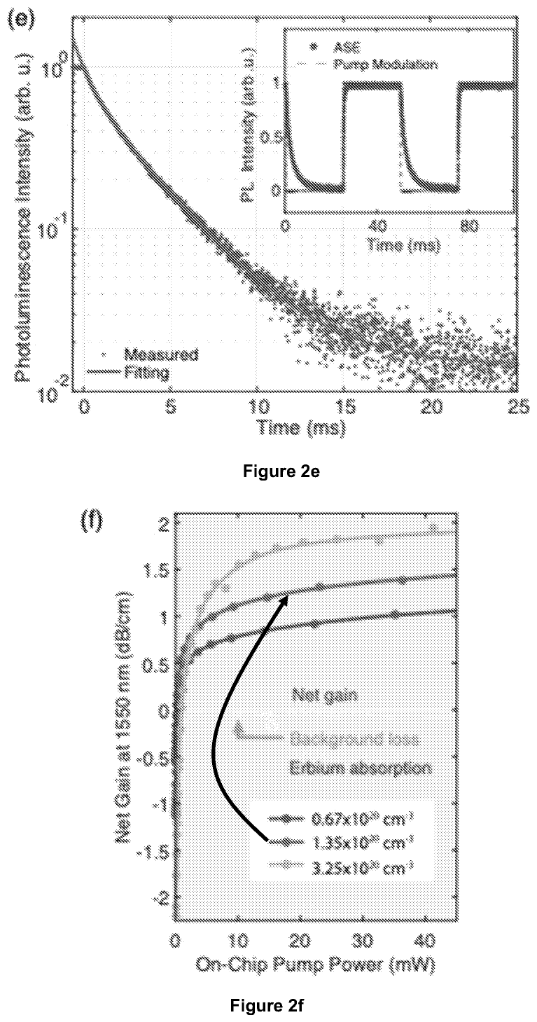

The emission and absorption cross-sections (σₑ(λ) and σₐ(λ)) are important parameters that can determine the erbium gain property. The Inventors infer σₑ(λ) and σₐ(λ) by examining the photoluminescence (PL) spectrum and the wavelength (λ)-dependent absorption loss, respectively. FIG. 2(a) shows the emission spectrum of the transition from the first excited level to the ground state by resonantly pumping the ⁴I_{11/2} state (980 nm) in a 0.46-cm-long Er:Si₃N₄ waveguide, from which the emission cross-section (FIG. 2(c)) can be derived via (23)

$$\frac{1}{τ} = 8 {π}^{2} c \int \frac{{σ}_{em} ( λ )}{{λ}^{4}} d λ , \qquad ( 1 )$$

where n is the refractive index and τ=3.4 ms is the PL lifetime extracted from the temporal measurement as shown in FIGS. 2(d) and (e). The wavelength-dependent erbium absorption loss α_{Er} (in cm⁻¹) is derived from the intrinsic resonance linewidths of an erbium-doped microring resonator. The absorption is subsequently converted to the erbium absorption cross-section using

$${σ}_{a} ( λ ) = \frac{{α}_{Er} ( λ )}{Γ \cdot {N}_{0}} , \qquad ( 2 )$$

where N₀ is the effective peak erbium ion concentration and Γ is the overlap factor. The insets of FIG. 2(b) show two resonances with intrinsic dissipation rates (κ₀/2π) of ˜1000 MHz and ˜40 MHz at 1535 nm and 1600 nm, corresponding to loss coefficients of 2 dB/cm and 0.08 dB/cm, respectively. The measured losses are calibrated by optical frequency domain reflectometry (OFDR) measurements. The absorption cross section σₐ(λ) is obtained by scaling its peak value to that of the derived σₑₘ(λ), which in turn gives the N₀ of 1.35×10²⁰ cm⁻³. Compared to the RBS result, almost all the incorporated erbium ions are optically active. Different erbium concentrations in Er:Si₃N₄ waveguides can be achieved by scaling the ion fluences. In reference Er:Si₃N₄ waveguides with ion concentration No of 0.67×10²⁰ cm⁻³, 1.35×10²⁰ cm⁻³ and 3.25×10²⁰ cm⁻³, the Inventors obtained net gain coefficients of 1.0 dB/cm, 1.4 dB/cm and 1.9 dB/cm at 1550 nm, respectively (FIG. 2(f)), comparable to the theoretical gain coefficients of 0.7 dB/cm, 1.5 dB/cm and 3.5 dB/cm given by g=Γ(σₑN₂−σₑN₁) where N₂ and N₁ are the populations of the first excited state and the ground state (24). The gain coefficient with 980 nm pump and its dependence on waveguide width is also investigated.

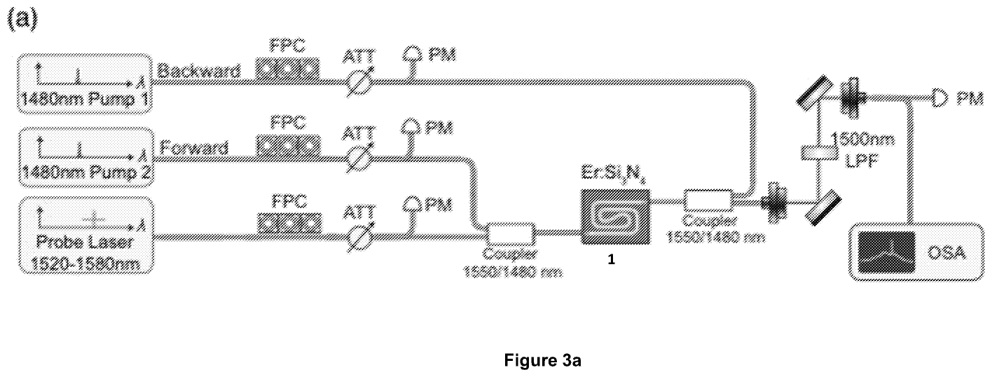

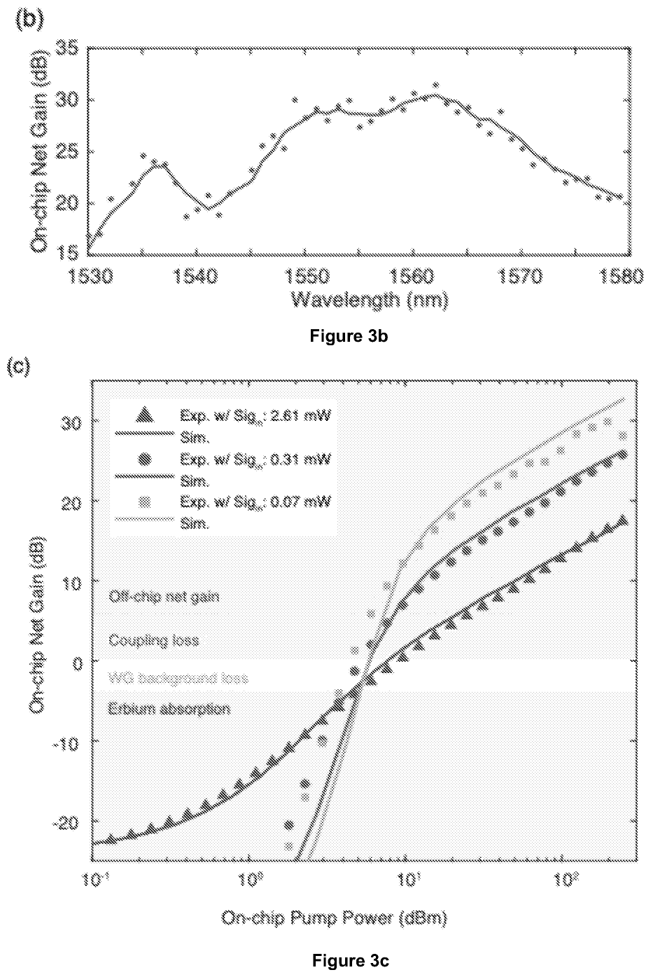

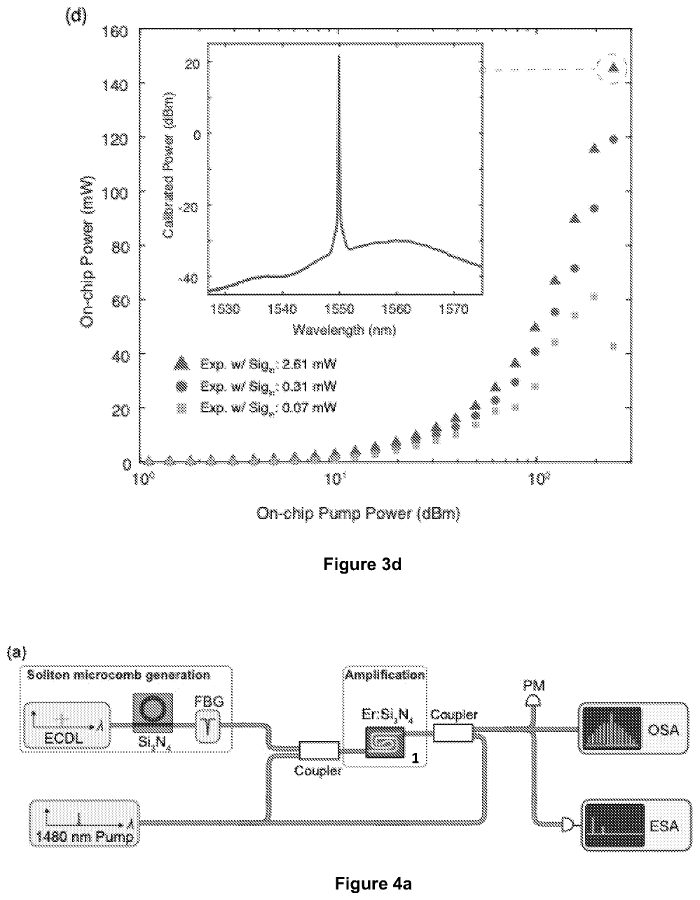

The Inventors demonstrate a high output power and a large net gain upon 1480 nm pumping in a 0.21-meter-long Er:Si₃N₄ waveguide with an erbium concentration of ca. 3.25×10²⁰ cm⁻³, using the setup as shown in FIG. 3(a). The broadband on-chip net gain reaches 30 dB over the wavelength range from 1550 nm to 1565 nm (FIG. 3(b)). FIG. 3(c) shows measured on-chip optical net gain at 1550 nm, along with simulations reproduced by parameter fitting. The on-chip output power reaches 60 mW for 0.07 mW input, yielding a maximum net gain of 30 dB and a power conversion efficiency of about 30% (signal power increment divided by pump power). This indicates an off-chip net gain of 24 dB when considering a two-side fiber-to-chip coupling loss of 5.8 dB. The Inventors achieve an on-chip output power reaching 145 mW for an increased input power of 2.61 mW at 245 mW coupled pump power, as shown in FIG. 3(d) and the inset, indicating an on-chip power conversion efficiency approaching 60%. A similar gain performance is achieved in a 0.5-meter-long Er:Si₃N₄ waveguide with a lower erbium concentration of ca. 1.35×10²⁰ cm⁻³. A noise figure of ca. 7 dB is measured at net gain of >20 dB. limited by coupling losses. Simulations suggest that a higher net gain and output power can be achieved with a higher pump power, without significantly suffering from the cooperative upconversion that can fundamentally limit the performance of EDWAs using co-sputtered erbium-doped films (15). It should be noted that the observed fluctuations in the measured net gain (yellow scatters) are caused by the gain clamping effect once the net gain reaches about 26 dB, which originates from the competing parasitic lasing in an optical Fabry-Pérot (FP) cavity formed by two waveguide facets.

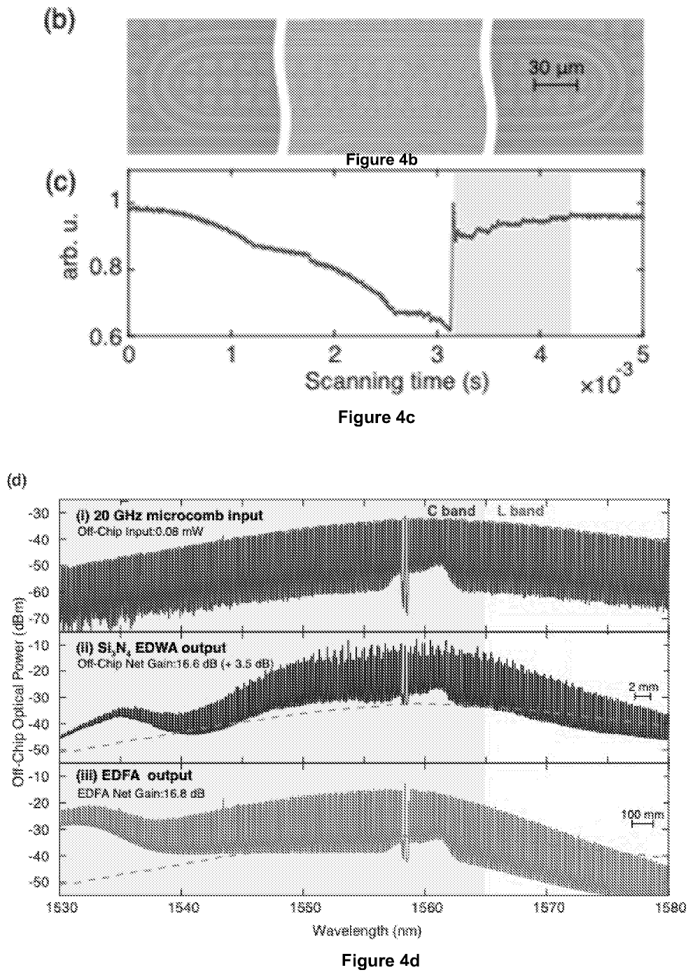

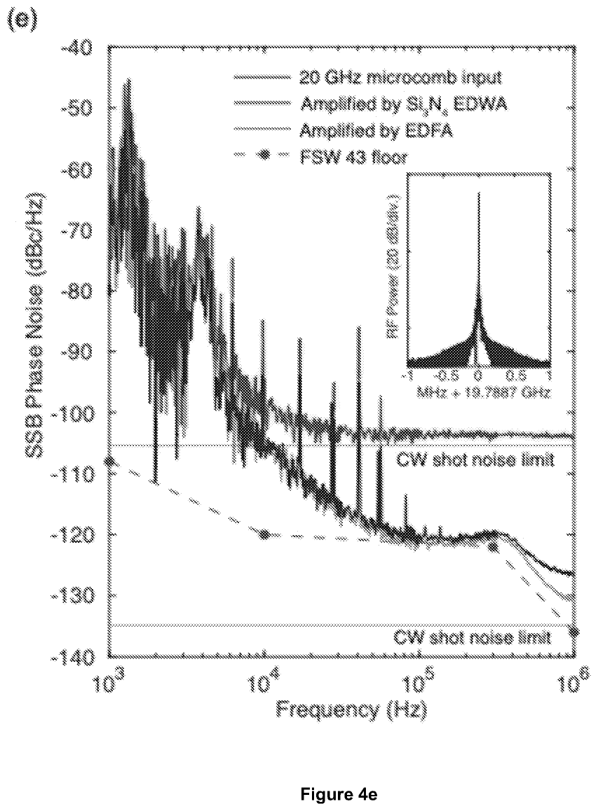

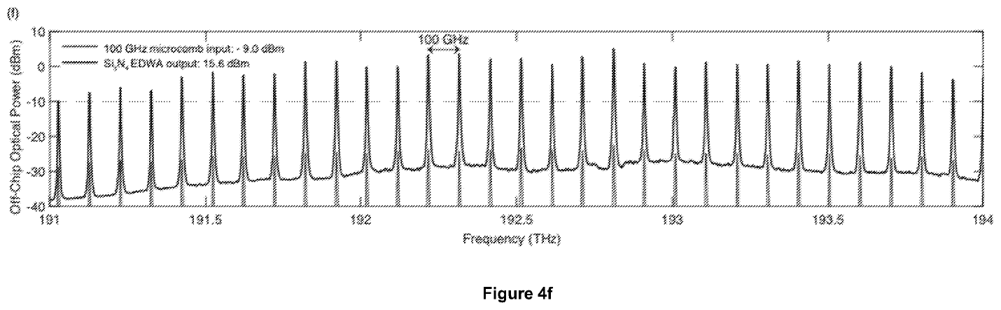

As an example of one of multiple possible utilities, the Inventors apply the Er:Si₃N₄ EDWA to soliton microcomb amplification (FIG. 4(a)) which, given both devices use Si₃N₄, can in principle be integrated on the same chip. Soliton microcombs can provide fully coherent broadband optical frequency combs when operating in the dissipative Kerr soliton (DKS) regime (25). Yet, soliton microcombs exhibit a low intrinsic nonlinear conversion efficiency (e.g., <1% for a 200 GHz spacing single-soliton microcomb (26)), requiring bench-top EDFAs to be used in virtually all applications. Here, the Inventors demonstrate on-chip amplification of soliton microcombs to 10 mW level across the C- and L-band, suitable for photonic generation of microwaves and in wavelength-division-multiplexing (WDM) coherent optical communications. First, a 19.8 GHz single-soliton microcomb is generated in a Si₃N₄ Euler-bend racetrack microresonator (FIGS. 4(b) and (c)) with 0.08 mW output power, as shown by panel (i) in FIG. 4(d). The amplified soliton with 8.4 mW off-chip power by the Er:Si₃N₄ EDWA (panel (ii)) leads to a significant reduction in single-sideband phase noise to <−120 dBc/Hz at Fourier offset frequencies at >100 kHz, compared to −104 dBc/Hz (before amplification) that is limited by photon shot noise, as shown in FIG. 4(c). To provide a comparison, a commercial EDFA is also deployed to amplify the same soliton microcomb to a similar power level (panel (iii) in FIG. 4(d)), giving identical performance.

As a second example, the Inventors amplify a soliton microcomb with a channel spacing of 100 GHz suitable for WDM optical communications. The Inventors observe more than 30 comb lines achieving line powers of >0.1 mW (−10 dBm) with an optical signal-to-noise ratio (OSNR) exceeding 30 dB (0.05 nm reso-lution bandwidth), among which more than 10 comb lines exceed 1 mW (0 dBm), as shown in FIG. 4(f). The observed comb line OSNR is envisaged to feasibly satisfy the requirement of the soliton-based transmitter for short-reach coherent data transmission at a symbol rate of 40 gigabauds per channel using 16-state quadrature amplitude modulation based on the same configurations as past work (27).

The Inventors thus demonstrates a waveguide amplifier, for example, a photonic integrated circuit-based erbium amplifier reaching 145 mW output power and more than 30 dB small-signal gain-on par with commercial fiber amplifiers and beyond state-of-the-art III-V heterogeneously integrated semiconductor amplifiers.

The design freedom afforded by photonic integrated circuits allows multi-stage configurations to be adopted, in order to optimize the gain and the optical signal-to-noise ratio.

Moreover, the ion implantation technique of the waveguide amplifier fabrication method of this disclosure could allow for co-doping other rare-earth ions with erbium ions such as ytterbium (emission at 1.1 μm) and thulium (0.8 μm, 1.45 μm and 2.0 μm), thereby additionally providing gain in other wavelength regions.

The disclosed method of ion implantation in Si₃N₄ can serve as the gain medium in a variety of integrated laser sources such as high-power soliton microcombs, low-noise rare-earth-ion-based CW lasers, femtosecond mode-locked lasers (28) or cavity soliton lasers (29). Equally important, this active Si₃N₄ photonic platform is compatible with heterogeneous integration of thin-films such a thin film lithium niobate, enabling the combination of both high-speed electro-optical modulation and amplification on the same chip, of use for coherent communications (27) or radio-frequency distribution (30).

Gain Performance Comparison with State-of-the-Art On-Chip Amplifiers:

Table 1 below summarizes the state-of-the-art prior works on integrated optical amplifiers, including planar amplifiers based on erbium-doped waveguide core or coating, as well as heterogeneously integrated III-V group semiconductor amplifiers. The Inventors compare the Er:Si₃N₄ waveguide amplifier demonstrated in this disclosure with the prior works and few commercial general purpose erbium-doped fiber amplifiers in terms of achievable on-chip output optical power, net gain, etc. The comparison shows that the PIC-based Er:Si₃N₄ amplifier of the present disclosure achieves a significant improvement in the output power and gain over reported erbium-doped approaches, reaching a comparable performance with the state-of-art heterogeneously integrated III-V amplifiers. It is also noted some amplification performance characteristics demonstrated in the present disclosure are on par with or even better than the specifications of some commercial erbium-doped fiber amplifiers. One can envisage that the demonstrated PIC-based Er:Si₃N₄ amplifier can replace such amplifiers in various applications and the small size of gain section can result in a significant form factor reduction.

TABLE 1
Comparison with reported on-chip amplifiers and typical commercial erbium doped fiber amplifiers. The gain
performance of the demonstrated Er:Si₃N₄ waveguide amplifier is compared with the state-of-the-art on-chip
amplifiers based on erbium-doped gain media and heterogeneously integrated III-V group semiconductors.
Three typical commercially available general purpose erbium-doped fiber amplifiers are also compared.

| | | | | | | |
|---|---|---|---|---|---|---|
| | | Maximum | Peak on-chip | | Erbium | |
| Waveguide | Active | on-chip output | net gain | Length | concentration | |
| material | material | power (dBm) | (dB) | (cm) | (cm⁻³) | Reference |

Si and Si₃N₄ photonic integrated circuit based devices.

| | | | | | | |
|---|---|---|---|---|---|---|
| Er:Si₃N₄ | Er:Si₃N₄ | 21.6 | 30 | 21 | 3.25 × 10²⁰ | This Work |
| Si₃N₄/Er:Al₂O₃ | Er:Al₂O₃ | −3.5 | 8.5 | 5.9 | 1.7 × 10²⁰ | Chrysostomidis et al.[1] |
| Si₃N₄/Er:Al₂O₃ | Er:Al₂O₃ | 2.7 | 18.1 | 10 | 1.65 × 10²⁰ | Mu et al.[2] |
| Si₃N₄ | Er:TeO₂ | <−1 | 5 | 6.7 | 2.5 × 10²⁰ | Frankis et al.[3] |
| Si₃N₄ | Er:Al₂O₃ | <−20 | 0.4 | 0.16 | 1.11-3.88 × 10²¹ | Rönn et al.[4] |
| Si | Er:Al₂O₃ | <−4 | 1.86 | 0.95 | 2.7 × 10²⁰ | Agazzi et al.[5] |

Planar waveguide devices based on oxide materials.

| | | | | | | |
|---|---|---|---|---|---|---|
| Er:Yb:Al₂O₃ | Er:Yb:Al₂O₃ | <−8.5 | 4.3 | 3 | 1.5 × 10²⁰ | Bonneville et al.[6] |
| Er:Al₂O₃ | Er:Al₂O₃ | 4 | 20 | 12.9 | 1.92 × 10²⁰ | Vázquez-Córdova et al.[7] |
| Er:Al₂O₃ | Er:Al₂O₃ | <−37 | 2.3 | 4 | 2.7 × 10²⁰ | G. N. van den Hoven et al.[8] |
| Er:Ta₂O₅ | Et:Ta₂O₅ | <−20 | 4.83 | 2.3 | 2.7 × 10²⁰ | Subramanian et al.[9] |
| Er:TeO₂ | Er:TeO₂ | 13 | 14 | 5 | 2.2 × 10²⁰ | Vu and Madden [10] |
| Er:LiNbO₃ | Er:LiNbO₃ | 0 | 18 | 3.6 | 1.9 × 10²⁰ | Zhou et al.[11] |

Low confinement waveguide based.

| | | | | | | |
|---|---|---|---|---|---|---|
| Er-doped | Er-doped | 4.4 | 27 | 47.7 | ≈4 × 10¹⁹ | Hattori et al.[12] |
| phosphate glass | phosphate glass | | | | | |
| Er-doped | Er-doped | 12 | 20 | 4.1 | ≈2.2 × 10²⁰ | Barbier et al.[13] |
| phosphate glass | phosphate glass | | | | | |
| Er-doped | Er-doped | 5.2 | 15 | 4.5 | ≈4 × 10²⁰ | Nykolak et al.[14] |
| soda-lime glass | soda-lime glass | | | | | |
| Er-doped | Er-doped | ≈19 | 16.7 | 3.1 | ≈1.8 × 10²⁰ | Della Valle et al.[15] |
| soda-lime glass | soda-lime glass | | | | | |
| Er-doped | Er-doped | ≈16 | ≈18 | 8.7 | ≈5.6 × 10¹⁹ | Thomson et al.[16] |
| bismuthate glass | bismuthate glass | | | | | |

III-V heterogeneous integrated amplifiers.

| | | | | | | |
|---|---|---|---|---|---|---|
| Si | III-V material | 17.5 | 27 | 0.145 | n/a | Van Gasse et al.[17] |
| Si | III-V material | 14 | 25 | n/a | n/a | Davenport et al.[18] |
| Si₃N₄ | III-V material | 8.8 | 14 | 0.115 | n/a | Op de Beeck et al.[19] |
| LiNbO₃ | III-V material | <5 | 11.8 | n/a | n/a | Op de Beeck et al.[20] |

Commercial erbium-doped fiber amplifiers (EDFAs).

| | | | | | | |
|---|---|---|---|---|---|---|
| Er-doped fiber | Er-doped fiber | 18 | [symbol] -35 | n/a | n/a | Calmar Laser AMP-PM-18 |
| Er-doped fiber | Er-doped fiber | 13 | >19 | n/a | n/a | Amonics AEDFA-BO-13 |
| Er-doped fiber | Er-doped fiber | >20 | >30 | n/a | n/a | Thorlabs EDFA100S |

n/a, data not available. [symbol]
indicates data missing or illegible when filed

Implantation to Si₃N₄ Waveguides without Lateral Cladding:

To further investigate the deformations of Si₃N₄ waveguides upon high-fluence ion implantation, the Inventors implanted Si₃N₄ ridge waveguides without lateral cladding 3 and characterized their geometries before and after implantation. The Si₃N₄ ridge waveguides used in this test was fabricated by standard UV lithography and RIE etching of a 350-nm-thick LPCVD Si₃N₄ film on wet oxidized Si wafer. Irradiation energies and fluences ratio are kept the same as those used for implantation to lateral cladded waveguides. The total fluence is 1×10¹⁶ cm⁻².

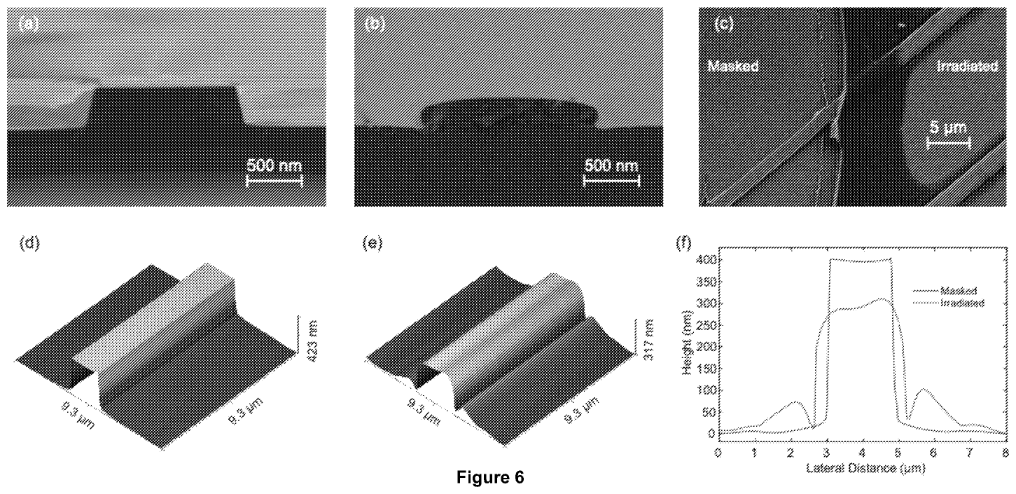

The Inventors noted a significant change in the waveguide cross section upon ion implantation, by comparing the SEM images of waveguides cross sections before and after implantation (FIGS. 6 (a) and (b)). Clearly, the profiles of the waveguide sidewalls and the top surface after implantation are severely deformed. The implanted waveguide cross sections appear to be wider and thinner compared to the masked waveguide, as shown in the top surface topography mapped by AFM (FIG. 6(d) and (2)). Such deformations are more severe in comparison to those observed in implanted waveguides with lateral cladding (FIGS. 5(b), (c) and (d)), which highlights the importance and necessity of the mechanical support from the lateral SiO₂ cladding.

Selective Masking for On-Demand Erbium Implantation in Complex Si₃N₄ Photonic Circuits:

As commonly done in the current microelectronics industry for semiconductor doping, areas of the PICS that are not intended to be gain sections can be masked before the implantation in order to avoid modifying the property of passive waveguides. Such selective implantation can sustain demanded properties such as ultra-low loss and engineered dispersion of passive devices, e.g., Kerr microring resonators, microring filters, couplers, and many others. Erbium absorption loss in devices where the pump light is not deliverable can also be avoided. This is a significant advantage over bulk doping during material growth reported in prior works using erbium-doped lithium niobate [111].

The Inventors demonstrate the feasibility of selective masking for erbium ion implantation using a simple photoresist masking process. In this process, the Inventors define the masked area by the standard UV direct-write lithography with 3 μm thick AZ 15nXT photoresist before the implantation. SRIM calculation indicates a 2 μm photoresist layer is enough to stop all of the erbium ions at 2 MeV. After the erbium ion irradiation, one notices that the photoresist shows signs of strong cross-linking and appears to be brown in color. The Inventors were able to completely remove the photoresist by ashing in high power oxygen plasma (15 min) and washing in HCl solution (37%, 45° C., 15 min).

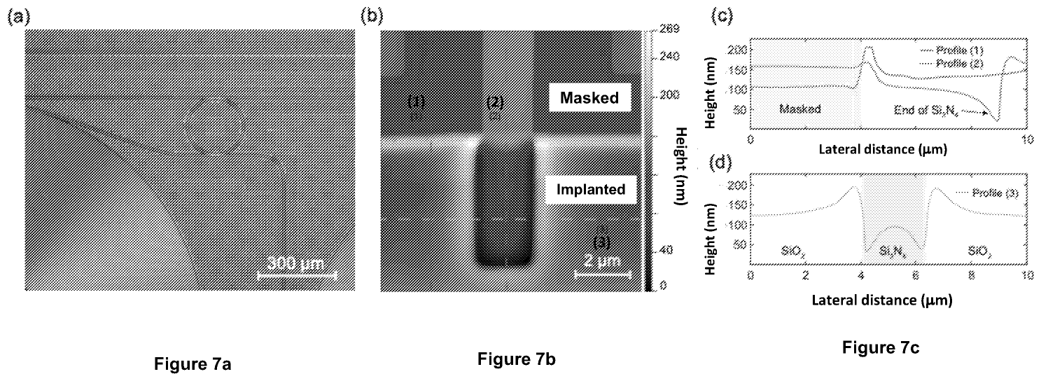

Although extreme ion energy and ion dose are applied in the waveguide doping, i.e., the ion energy is comparable to implants used in the imaging sensor industry, and the dose is comparable to those for creating ohmic contacts in SiC processes [126]. This simple masking process worked surprisingly well in the demonstration. As shown in FIG. 7(a), after the photoresist is removed, a clear contrast between implanted and masked areas can be observed under an optical microscope, which provides evidence of material property modification by the ion irradiation.

For the scope of future developments towards more complicated active Si₃N₄ photonic integrated circuits, one also notice that the implanted areas can undergo some topography changes due to material volume expansion and stress accumulation. As shown in FIG. 7(b), one observes minor local deformations of SiO₂ at the boundary between the implanted area and masked area. The implanted Si₃N₄ core appears to expand in volume, squeezing our adjacent lateral SiO₂ cladding and creating small humps around the waveguide with a height variation on the order of 50 nm. This observation agrees with the geometry change in cross section, as shown in FIGS. 5(c) and (d).

The Inventors simulated the fundamental TE optical mode field based on the SEM measured geometry shown in FIGS. 5(c) and (d) at 1550 nm. Assuming the transition between implanted waveguide cross section to unimplanted cross section is sudden, by computing the mode overlap, it is estimated that the fundamental mode to fundamental mode transmission loss at the boundary to be <0.018 dB and the return loss <−45 dB. Although the reflection and scattering caused by the ‘step-like’ feature at the boundary are fairly small for many applications, one can apply methods such as introducing a grayscale mask or a tapering mask above the waveguide at the boundary to engineer a smooth transition and further reduce the reflection and scattering.

### Erbium Ion Distribution and Overlap Factor Calculation:

To ensure a maximum overlap of the erbium ion distribution and the optical intensity in the Si₃N₄ waveguides, the Inventors do three consecutive implantations of ¹⁶⁶Er⁺ at different energies and thus different ion ranges. They optimize the implantation energies and fluences for the overlap according to the Stopping and Range of Ions in Matter (SRIM) calculations [27]. In the SRIM calculation, it was used a density of 3.17 g/cm³ for stoichiometric Si₃N₄. A Monte Carlo simulation with the Transport of Ions in Matter (TRIM) code is used later to obtain a more precise density distribution. The ion energies, TRIM simulated ion distribution parameters and the implantation fluences are listed in Table 2. It is noted that the fluence received by some earlier samples is lower than expected by a factor of 0.42 or even lower due to a sample mounting issue. Rutherford backscattering spectroscopy (RBS) and optical absorption measured in ring resonators are used to calibrate the actual erbium concentration, which has been presented earlier.

TABLE 2
Parameters applied in the three consecutive
erbium implantation into Si₃N₄ waveguides.

| Energy | Ion | Straggling | Ion fluence |
|---|---|---|---|
| (MeV) | range (nm) | (nm) | (ions/cm²) |
| 0.955 | 197.4 | 40.0 | 2.34 × 10³⁵ |
| 1.416 | 284.9 | 55.3 | 3.17 × 10¹⁵ |
| 2.000 | 398.1 | 74.1 | 4.5 × 10¹⁵ |

Benefiting from the large doping depth (comparable to the waveguide thickness) and optimized vertical distributions, the ion implantation approach allows to achieve a large overlap factor between the erbium ions and optical modes. Based on the parameters provided in Table 2, it is estimated that the overlap factor Γ between erbium density distribution and the intensity of the fundamental TE mode of interest at 1550 nm to be ˜0.49, in a waveguide with a transversal (cross-sectional) dimension of 2.1 μm×0.7 μm. One can note that the actual overlap factor can be higher up to ˜ 0.6 for thinner waveguides, considering fabrication-induced thickness variation of samples.

Here the Inventors defined the maximum Erbium concentration normalized Γ as

$$Γ = \frac{\int \int N ( y ) ϵ ( x , y ) {E}^{2} ( x , y ) dxdy}{max ( N ( y ) ) \int \int ϵ ( x , y ) {E}^{2} ( x , y ) dxdy}$$

where E(x,y) is the electric field of the fundamental TE mode, E(x,y) is material relative permittivity and N(y) is the depth-dependent ion concentration.

### Rutherford Backscattering Spectroscopy (RBS) Measurement and Analysis:

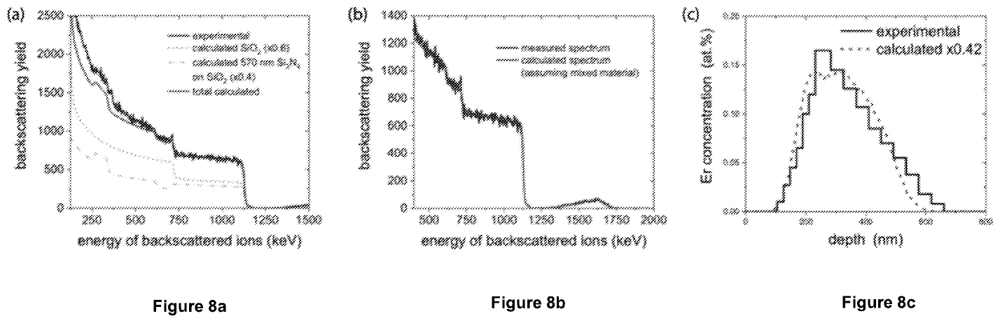

The Er concentration profile of the implanted and annealed sample from the same wafer has been analyzed by Rutherford backscattering spectrometry (RBS) measurements using 2 MeV He ions. The ion beam diameter was about 1 mm, the backscattered ions were detected at 170° in respect to the incident ion beam and the total ion charge was 5 μC for collecting one spectrum. The measured spectrum (blue lines in FIG. 8(a)) was calibrated by measuring additionally a thin surface layer sample containing several elements.

As the sample consists of exposed areas of Si₃N₄ and SiO₂, firstly the relative coverage area of them had to be determined. This is done by fitting the simulated RBS spectrum (red line FIG. 8(a)) to the respective Si, N and O signals appearing at about 1125, 730 and 625 keV, respectively, which results to a coverage fraction of SiO₂:Si₃N₄=0.4:0.6, as shown in FIG. 8(a). Next, the Er signal located between 1350 and 1750 keV and clearly visible in FIG. 8(b) was analyzed in detail. A very good fit of simulated and measured RBS spectra was obtained by assuming layers with different Er concentrations of thicknesses ranging from 20-40 nm, which represents the depth resolution of the performed RBS measurements. As RBS measures the density profile in thin film units, the depth scale in FIG. 8(c) of the measured Er concentration is converted to physical depth assuming the density of Si₃N₄ to be 9.65 ×10²² atoms/cm³ (3.17 g/cm³). A good agreement is obtained of the shape of the measured profile with the one calculated by SRIM, also shown in main manuscript, but the absolute erbium concentration measured is lower by a factor of 0.42 than expected from the nominal implantation fluences.

Loss Characterization of Erbium-Implanted Er:Si₃N₄ Waveguides.

The wavelength-dependent waveguide losses of the Er:Si₃N₄ circuits need to be carefully characterized, in order to infer the waveguide background loss, erbium absorption and the net gain coefficient. Here, the Inventors use two methods, i.e. the microring resonance linewidth characterization and the optical frequency-domain reflectometry (OFDR), to calibrate the waveguide losses.

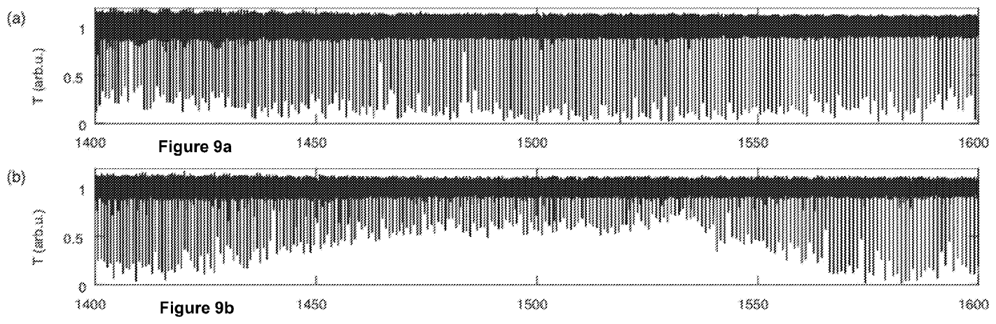

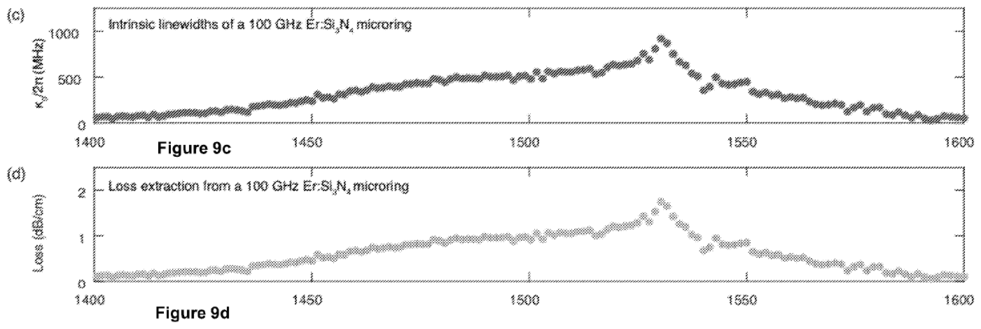

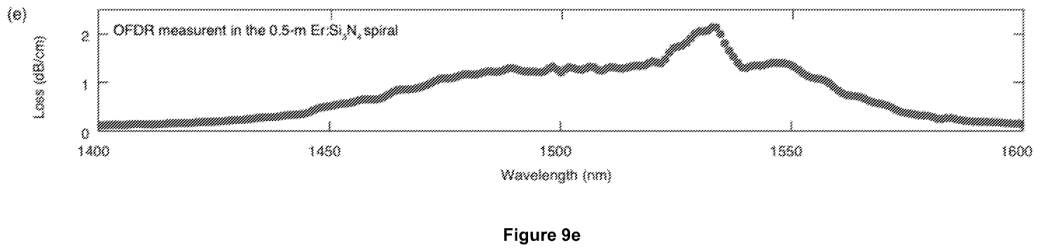

The Inventors first characterize the resonance linewidth of a 100 GHz Er:Si₃N₄ microring resonator side coupled with a single bus waveguide. FIGS. 9(a) and (b) show the optical transmission spectra of the microring before the erbium ion implantation and after the implantation and annealing, respectively, using a home-built sub-MHz-resolution optical network analyzer [128, 129]. Variations in the resonance dip depth are observed, which are associated with changes in intrinsic linewidth Δv₀=κ₀/2π. The intrinsic dissipation rate κ₀ is inferred from fitting of the measured resonance to a Lorentzian lineshape, as shown in FIG. 9(c). The optical loss α (in 1/m) is converted from the intrinsic dissipation rate via the expression given by

$$α = \frac{{η}_{eff} {κ}_{0}}{c} ,$$

where n_{eff} is the effective refractive index and c is the light speed in vacuum. The calculated waveguide loss is shown in FIG. 9(d), indicating a peak value of ˜1.75 dB/cm at 1535 nm

Secondly, the Inventors characterize the propagation loss in a 0.5-m-long Er:Si₃N₄ waveguide via OFDR measurements. The OFDR traces record the optical back reflection along the waveguide length, which can be converted to propagation loss by linear fitting of the distance-dependent optical backreflectance. By fitting the loss in various segmented spectral windows, the wavelength-dependent loss is obtained, as shown in FIG. 9(e). The characterized loss from the OFDR measurement in general agrees with the loss inferred from the intrinsic resonance linewidth measurement, while exhibiting a slightly higher peak value of 2.14 dB/cm at 1535 nm. This difference is attributed to the possible reduced erbium absorption caused by the cavity enhanced optical intensity for the case of resonance linewidth measurements. In gain calculations and simulations, we use the losses inferred from the OFDR measurements.

### Photoluminescence Lifetime Measurement:

The photoluminescence (PL) lifetime t of the transition from the excited state ⁴I_{13/2} to the ground state ⁴I_{15/2} is measured from a 0.45 cm-long Er:Si₃N₄ waveguide, in order to avoid the possible erbium re-absorption in long waveguides. A 980 nm pump laser diode is gated by a periodic square wave with a duty cycle of 50% and a duration of 50 ms. The coupled pump power is limited to <1 mW level to minimize the effect from cooperative upconversion processes [130]. When the modulated pump is switched off, the spontaneous emission decays at a rate inversely pro-portional to the PL lifetime τ. An increased lifetime τ of 3.4 ms for the decay to its 1/e of the maximum is obtained from exponential curve fitting, compared to 1.5 ms before annealing.

### Gain Coefficient Analysis for Different Pump Wavelengths and Waveguide Cross Sections:

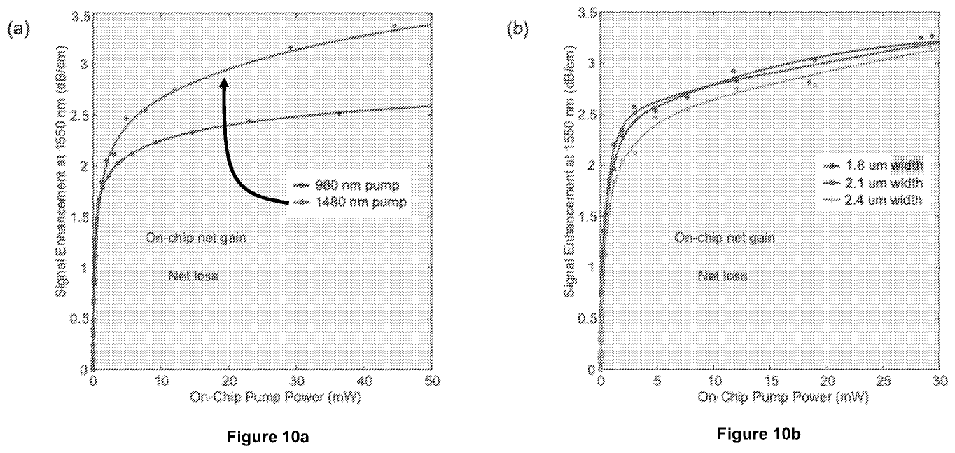

Firstly, the Inventors investigate the gain coefficients in a short (0.43-0.46 cm) Er:Si₃N₄ waveguide at different pumping wavelength, as shown in FIG. 10(a). A maximum signal enhancement of 3.4 dB/cm at 1550 nm is obtained for 980 nm pumping, which is higher than the peak value of 2.5 dB/cm upon 1480 nm pumping, due to the more complete population inversion upon 980 nm pumping. A net gain coefficient of 2.3 dB/cm for 980 nm pumping is obtained by subtracting the total losses from erbium absorption and waveguide background loss, while a net gain coefficient of 1.4 dB/cm for 1480 nm pumping. The theoretic gain coefficient is given by g=σₑΓN₀ (1.7 dB/cm) [131]. For experiments presented in the manuscript, 1480 nm pumps are deployed due to the lower coupling loss and the cut-off wavelength (1450 nm) of the UHNA fibers for chip coupling.

Secondly, FIG. 10 (b) compares the optical net gain of waveguides doped with the same erbium ion fluence, but different widths. The saturated gain of the three waveguides with 1.8 μm, 2.1 μm, and 2.4 μm width is the same within the measurement error. From the gain-pump power relation, we find that the 1.8 μm and 2.1 μm waveguides reach saturation at the same rate while the 2.4 μm waveguide has a slightly higher pump saturation power due to the relatively larger effective mode area. The gain performance can be further enhanced by adopting increased waveguide cross section dimensions to achieve a larger mode area for higher output saturation power. This result indicates that Er:Si₃N₄ waveguides with 1.8 μm to 2.4 μm widths have similar amplification performance, which permits flexible design of waveguide geometry for optical dispersion engineering for applications such as mode-locked laser and active cavity solitons.

In experiments, the Inventors measure the power of 1550 nm signal before and after passing the short waveguides pumped with varied optical power. The signal enhancement which is the difference of the maximum and the minimum output signal power is derived. The net optical gain is then computed by subtracting the characterized erbium absorption loss at 1550 nm from the measured signal enhancement. The on-chip input signal power is set at −31 dBm to avoid gain saturation and ensured the output signal level is higher than the total power of amplifier spontaneous emission (ASE) power by at least 5 dB. The ASE level is calibrated without the signal input, which is then subtracted from the measured total output signal power. Wavelength division multiplexers (Thorlabs WD1450A) and free-space thin-film optical filters (Thorlabs FB1550-40 and FEL1500) are used to suppress residual pump light by −60 dBc in output signal power measurements.

Numerical Modeling of Optical Amplification in Er:Si₃N₄ Waveguides:

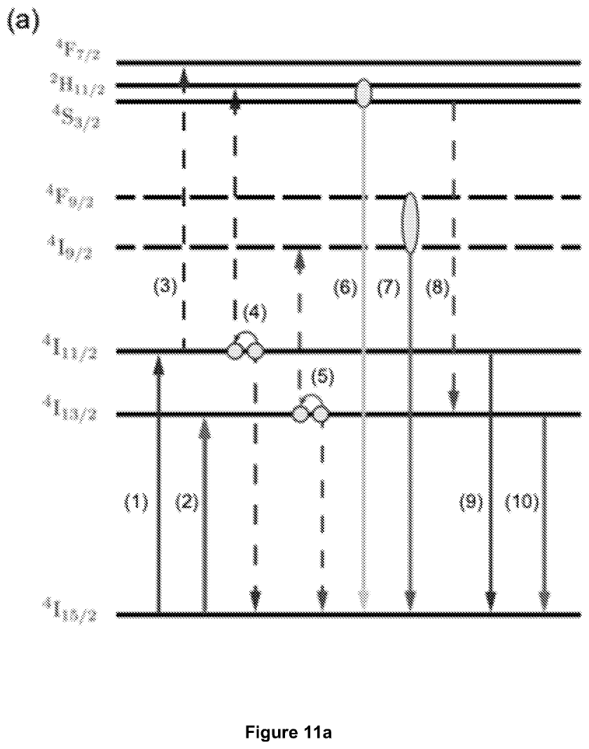

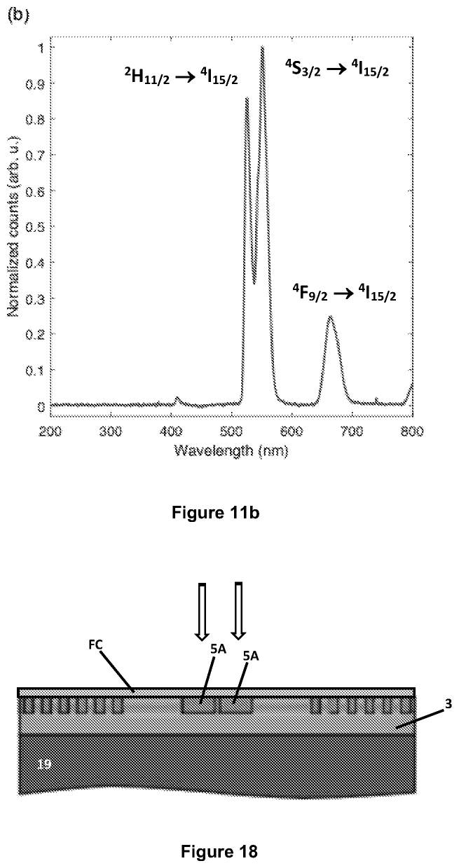

The Inventors model the optical gain by treating the erbium as a three-level system that generally well describes the populations in the first three lower-lying levels (⁴I_{15/2}, ⁴I_{13/2} and ⁴I_{11/2}), as shown in FIG. 11(a). The rate equations that govern the population dynamics including excited state absorption (ESA), first- and second-order cooperative upconversions (CUC) upon pumping with 1480 nm are given by [132, 133] (equations (3)),

$$\frac{d {N}_{3}}{dt} = - ( {A}_{32} + {C}_{37} {N}_{3} ) {N}_{3} + ( {R}_{24} + {C}_{24} {N}_{2} ) {N}_{2} ,$$

$$\frac{{dN}_{2}}{dt} = - ( {A}_{21} + {R}_{21} + {R}_{24} + 2 {C}_{24} {N}_{2} ) {N}_{2} + {R}_{12} {N}_{1} + {A}_{32} {N}_{3} ,$$

$$\frac{{dN}_{1}}{dt} = - {R}_{12} {N}_{1} + ( {A}_{21} + {R}_{21} + {C}_{24} {N}_{2} ) {N}_{2} + {C}_{37} {N}_{3}^{2} ,$$

where N_{1,2,3} indicates the populations at the first three levels ⁴I_{15/2}, ⁴I_{13/2} and ⁴I_{11/2} respectively. Aᵢⱼ=1/τᵢⱼ is the decay rate from level i to level j, given by the inverse of the life time τᵢⱼ. Rᵢⱼ=σijφ is the transition rate of optical beams (signal, pump and spontaneous emission) from state i to state j, where φ=I/hvₖ is the photon flux, σij is the hvₖ transition cross section, I is the optical intensity and v is the photon frequency.

R₂₄ presents the transition rate of ESA from the ⁴I_{11/2} level, while C₂₄ and C₃₇ are responsible for the first- and second-order cooperative upconversions, respectively. These terms are included in the numerical calculations, although it has been demonstrated that C₃₇ could be small for ion implanted substrate with respect to co-sputtered doped film, due to the relatively homogeneous erbium distribution [133]. N=N₁+N₂+N₃ is the total ion concentration.

In the waveguide, the spatial distributions of the signal, pump and the spontaneous amplifier noises can be described by a set of propagation Eq given by (Equations 4)

$$\frac{{dP}_{s} ( s )}{dz} = {P}_{s} ( z ) {Γ}_{s} [ {σ}_{21 s} {N}_{2} ( z ) - {σ}_{12 s} {N}_{1} ( z ) ] - {P}_{s} ( z ) {α}_{0 s} ,$$

$$\frac{{dP}_{p} ( s )}{dz} = {P}_{p} ( z ) {Γ}_{p} [ {σ}_{21 p} {N}_{2} ( z ) - {σ}_{12 p} {N}_{1} ( z ) ] - {P}_{p} ( z ) {α}_{0 p} ,$$

$$\frac{{dP}_{ASE , f} ( z )}{dz} = {P}_{ASE , f} ( z ) {Γ}_{ASE} [ {σ}_{21 , ASE} {N}_{2} ( z ) - {σ}_{12 , ASE} {N}_{1} ( z ) ] + {P}_{ASE}^{0} {σ}_{21 , ASE} {N}_{2} ( z ) - {P}_{ASE , f} ( z ) {α}_{0 , ASE} ,$$

$$\frac{{dP}_{ASE , b} ( z )}{dz} = {P}_{ASE , b} ( z ) {Γ}_{ASE} [ {σ}_{21 , ASE} {N}_{2} ( z ) - {σ}_{12 , ASE} {N}_{1} ( z ) ] - {P}_{ASE}^{0} {σ}_{21 , ASE} {N}_{2} ( z ) + {P}_{ASE , b} ( z ) {α}_{0 , ASE} ,$$

where Γ is the mode-erbium overlap factor, α₀ₛ and α₀ₚ are the waveguide background losses for the signal and pump, respectively. P⁰_{ASE}=2BhV_{ASE} is the added local spontaneous emission noise power within a bandwidth of B (˜5 THz in simulations) for two polarizations. In simulations, we include the amplifier spontaneous emission noises propagating in both directions. For the cases with counter-propagating optical beams such as in backward pumping and and bidirectional pumping configurations, the above Equations need to be expanded to include both forward and backward propagating pumps and can be solved as an ordinal differential equation boundary value problem by algorithms such as the relaxation algorithm.

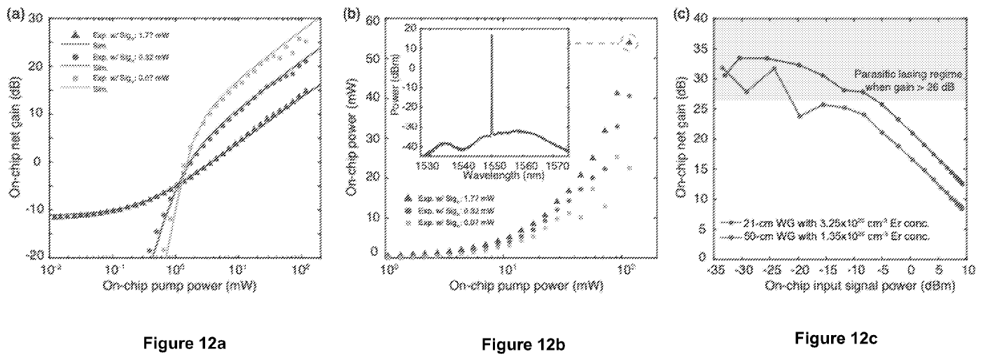

FIG. 12(a) shows the numerical fitting to the measured optical gain using simulations based on Equations 3 and Equations 4, in order to estimate the contributions from ESA and CUC processes. The corresponding output powers are shown in FIG. 12(b). The experimental results presented in the main manuscript are reproduced using the parameters listed in Table 3.

TABLE 3
Parameters utilized in simulations of on-chip optical net gain in a 0.5-m Si₃N₄ waveguides for −10 dBm input at 1550 nm.

| Parameter | N₀(cm⁻³) | τ₃₁ (ms) | τ₃₂ (μs) | σ₃₁ₚ(cm⁻²) | σ₁₂ₚ(cm⁻³) | σ₂₁ₛ(cm⁻²) | σ₁₂ₛ(cm⁻²) | σ₃₄(cm⁻²) | [symbol] ₂₄(cm³s⁻¹) | [symbol] ₃₇(cm³s⁻¹) |
|---|---|---|---|---|---|---|---|---|---|---|
| Value | 1.35 × 10²⁰ | 3.4 | 20 | 1.07 × 10⁻²¹ | 4.48 × 10⁻²¹ | 6.76 × 10⁻²¹ | 4.03 × 10⁻²¹ | 1.0 × 10⁻²³ | 3.0 × 10⁻¹⁸ | 1.0 × 10⁻¹⁸ |

[symbol]

indicates data missing or illegible when filed

The simulations suggest that the observed optical gain is not obviously limited by the second order cooperative upconversion C₃₇, even in the regime with >120 mW on-chip pump power due to the small C₃₇ from the numerical fitting of measured results. Despite the weak C₃₇, we observed the green luminescence induced by the transition from higher-lying levels upon intense pumping, as shown in FIG. 11(b). FIG. 12(c) shows the net gain as a function the input signal power P_{sat,s} at 1550 nm, from which the input saturation power is estimated to be around −15 dBm (where small-signal gain drops by 3 dB), approximately matched with the theoretical value of −14 dBm given by

$${P}_{sat , s} = \frac{{hv}_{s}}{( {σ}_{21 s} + {σ}_{12 s} ) {τ}_{21} {A}_{eff}}$$

where the A_{eff}=1.2 μm² is the effective area of the fundamental TE mode.

The shaded area indicates the regime where parasitic lasing kicks in when the net gain exceeds 26 dB, which leads to fluctuations in measured net gain and causes uncertainty in the estimation of saturation input power. The vertical offset between the net gains from two samples is mainly caused by the difference in coupled pump powers.

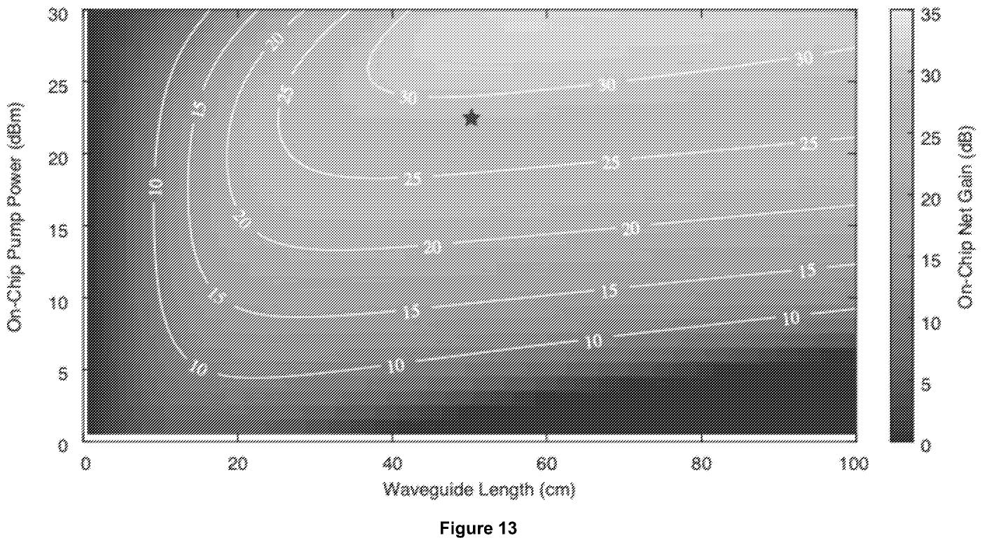

FIG. 13 presents the simulated on-chip net gain as functions of the pump power and the waveguide length. An optimized waveguide length of 0.5-m can be found for an Er:Si₃N₄ amplifier for the demonstrated erbium concentration of ˜1 ×10²⁰ cm⁻³, capable of delivering an optical net gain exceeding 30 dB and an on-chip output power of 20 dBm (100 mW) with an on-chip power pump of around 23 dBm. The further increase of the waveguide length would not significantly contribute to a higher net gain, as the signal re-absorption by erbium can take place in the presence of the pump depletion and attenuation in longer waveguides. In experiments, due to the power limit of the laser diode and coupling loss, the Er:Si₃N₄ waveguide amplifier can operate around the regime indicated by the marker shown in FIG. 13, for achieving 26 dB gain. Indeed, it is feasible to further increase the gain using a higher on-chip pump power exceeding 23 dBm, however, it would be limited to ˜30 dB by the excited state absorption (determined by σ₂₄) according to the simulations. In contrast, no significant contributions from cooperative upconversion processes determined by C₂₄ and C₃₇ are observed in simulations at pump levels of >200 mW. The fitted coefficients C₂₄ and C₃₇ of the samples based on ion implantation are two orders of magnitude lower than what have been reported in sputtered erbium-doped Al₂O₃ [104, 130, 133].

### Experimental Setup for Gain and Output Power Measurements:

The integrated waveguide amplifier is excited by pump lights provided by multi-longitudinal-modal laser diodes centered around 1480 nm (400 mW power at the fiber pigtail output), which are injected to the photonic chip via coupled fibers in both forward and backward directions. Here, the Inventors use 1480 nm pumping due to the lower fiber-to-chip coupling loss, despite a higher gain coefficient with 980 nm pumping. The probe signal emitted from a frequency-tunable continuous-wave (CW) laser is coupled to the chip, after combined with the forward optical pump via a fiber-based coupler (wavelength-division multiplexer for 1480/1550 nm). The transmitted pump is filtered out by a high-extinction free-space low-pass filter, to ensure accurate gain characterization. The measured signal and pump powers are carefully calibrated with characterized insertions losses caused by fiber links, optical couplers and optical filters. The optical spectra are calibrated with the optical powers measured by power meters. We extract the net gain by directly comparing the output and input signal powers after calibrations, instead of using subtraction between signal enhancement and total loss which might lead to overestimation of the net gain.

### Fresnel Reflection at Chip Facets and Induced Parasitic Lasing:

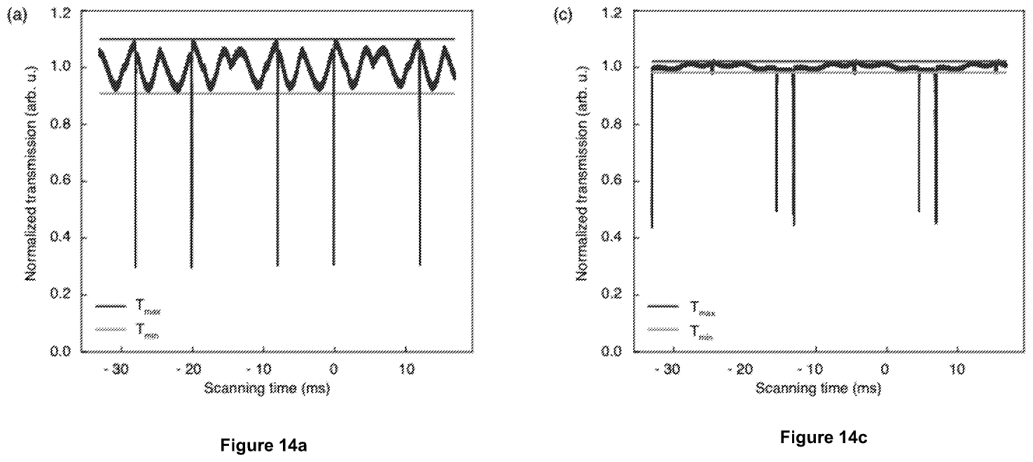

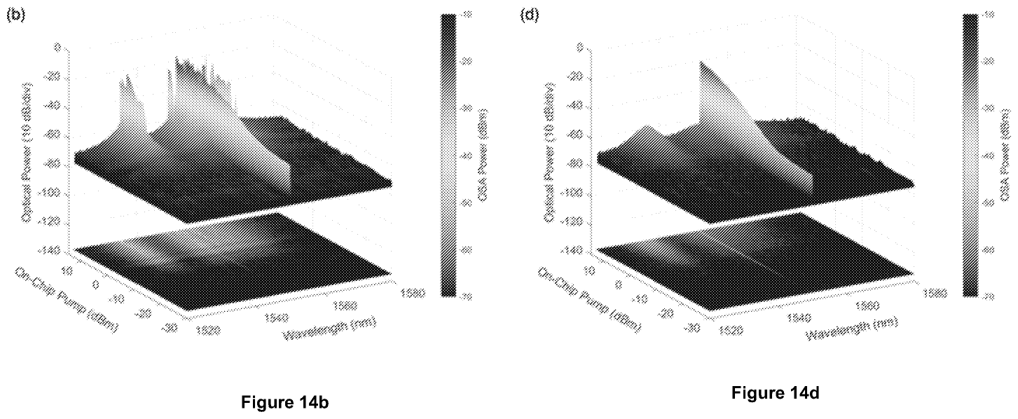

The Fresnel reflection of the waveguide input and output at the chip facets can form an optical Fabry-Pérot (FP) cavity that can lead to resonance enhancement at resonance frequencies. FIG. 14(a) show the transmission of a passive 100 GHz FSR Si₃N₄ microring resonator coupled with a 0.5-mm-long bus waveguide when using lensed fibers for light coupling in and out of the chip. The laser frequency is scanned over 30 GHz with a period of 20 ms. The baseline variation stemmed from the FP cavity fringes. Assuming the same reflectance for both facets and negligible waveguide loss, the intensity reflection coefficient R can be inferred from the contrast K of the fringes via the expression

$$R = \frac{1 - \sqrt{1 - {K}^{2}}}{K} .$$

The contrast is given by

$$K = \frac{{I}_{max} - {I}_{min}}{{I}_{max} + {I}_{min}}$$

where Iₘₐₓ and Iₘᵢₙ are the fringe maxima and minima, respectively. This gives a calculated intensity reflection coefficient R=4.77%, corresponding to a −13 dB return loss at each facet. When the on-chip gain is sufficient to overcome the waveguide loss and the return loss, parasitic lasing of the F-P cavity can take place in the on-chip waveguide amplifier at wavelengths other than the input signal wavelength. This effect will limit the achievable optical gain. In a 0.5-m-long Er:Si₃N₄ waveguide amplifier, the parasitic lasing will limit the single-pass on-chip net gain to around 16 dB, when considering a 3 dB background loss. FIG. 14(b) shows an example of parasitic lasing for-10 dBm signal input at on-chip pump powers of >10 dBm. With the unstable parasitic lasing, the amplified signal power exhibits fluctuations and does not show a clear increase when the pump power ramps up.

In contrast, the Fresnel reflection can be suppressed by reducing the refractive index mismatch caused by the air gap between the chip facets and coupled fibers. Here, the Inventors use a pair of ultra-high numerical aperture (UHNA) optical fibers that are butt-coupled against the input and output chip facets, respectively. The UHNA fibers are perpendicularly cleaved to provide flat end facets in contact with the Er:Si₃N₄ chip facets. The UHNA fiber (UHNA7, Coherent Inc.) has a small mode field diameter of 3.2 μm that approaches the optical mode size in the inversely tapered Si₃N₄ waveguides. Index matching gel (G608N3, Thorlabs Inc.) is applied to the air gap between the UHNA fibers and the chip facets to reduce the Fresnel reflection by one order of magnitude from 4.77% to 0.5%, corresponding to a reflection loss of −23 dB, as shown in FIG. 14(c). The reduced reflection raise the threshold for parasitic lasing, which in turn allows for on-chip net gain up to 26 dB. In this case, no obvious parasitic lasing is observed in the same Er:Si₃N₄ waveguide with the same input signal, as shown in FIG. 14(d).

The parasitic lasing can still takes place when the net gain exceeds 26 dB for either smaller input signals or increased pump powers, since the waveguide can provide sufficient high single-pass gain to surpass the FP cavity losses at one end, i.e. −23 dB for inward Fresnel reflection and −3 dB for waveguide background loss. Further reduction of facet reflection by angled waveguide tapers and facets will facilitate a higher achievable net gain. In experiments, fiber-to-chip coupling losses are 2.9 dB and 3.3 dB per side for 1550 nm and 1480 nm, respectively.

Noise Figure of the Er:Si₃N₄ Amplifier:

The noise figure of the Er:Si₃N₄ amplifier is measured using the commonly used optical source subtraction method that can remove the source spontaneous emission (SSE) noise from the total noise emitted by the erbium amplifier. In the measurement, the spectra of the input laser signal and the amplified signal recorded by an optical spectrum analyzer (OSA) are calibrated with respect to their powers measured by a power meter. The optical insertion loss between the amplifier output and the OSA is measured and then compensated in calculations. The optical gain G at the optical frequency v and noise powers at the input P_{SSE} and the output Pₒᵤₜ within an optical bandwidth Bo are measured from the calibrated optical spectra, in order to derive the noise figure using the expression given by

$$NF = \frac{{P}_{out} - {GP}_{SSE}}{{GhvB}_{0}} + \frac{1}{G} .$$

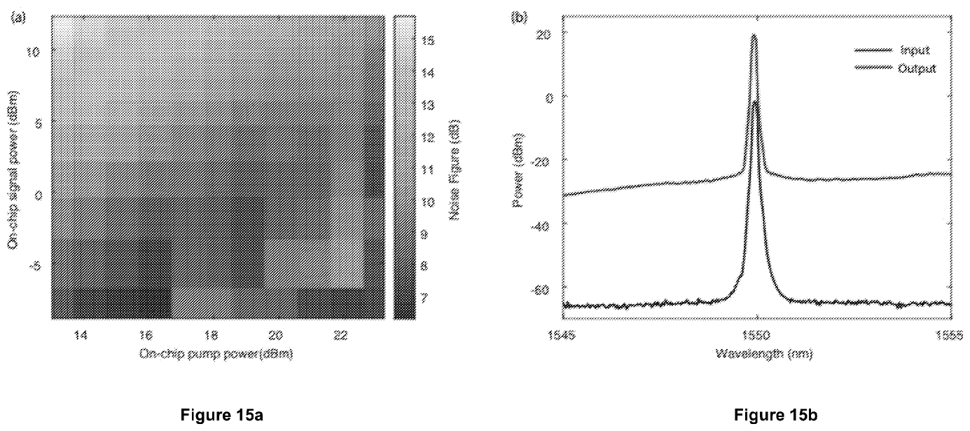

The derived noise figures at various input signal powers and pump powers for a forward pumping scheme are shown in FIG. 15(a). In the high-gain regime with >20 dBm on-chip pump power and <−5 dBm off-chip signal power, the noise figure measurement is affected by the parasitic lasing effect that limits the optical gain. FIG. 15(b) shows an example noise figure measurement with an off-chip input signal of −1.9 dBm (marked in Fig. S15(a)).

An off-chip optical net gain of 21 dB is obtained from the optical spectrum difference at the signal wavelength. The noise powers Pₒᵤₜ=−27 dBm and P_{SSE}=−65 dBm over 0.2 nm optical bandwidth (the resolution bandwidth of the OSA) are interpolated from the noise floors at wavelengths 3 nm away from the signal peak, respectively. In order to avoid overestimate the noise figure, the Inventors use the corrected resolution bandwidth of 0.12 nm instead of the displayed 0.2 nm resolution bandwidth of the OSA. Using the previous Equation, a noise figure of 7.1 dB is obtained, including the contribution from the input fiber-to-chip coupling loss and relatively large spontaneous emission factor nₛₚ upon a 1480 nm pumping (incomplete population inversion).

### On-Chip Amplification of Soliton Microcombs and Photonic Generation of Microwaves:

The soliton microcomb is generated by slow laser tuning and a single soliton is isolated using the backwards tuning technique [138]. The generated single-soliton microcomb exhibits a characteristic sech-squared spectral envelope with an integrated power of 0.08 mW (transmitted pump is removed by fiber Bragg grating notch filters), when being excited by an on-chip pump power of around 100 mW. The measured soliton microcomb power is lower than the theoretically fitted power (0.3 mW), due to the additional optical attenuation from the chip coupling, as well as the fiber link loss between the coupled fiber and photodetector. The fitted comb line power is given by

$$P ( μ ) = \frac{\vert {β}_{2} \vert {D}_{1}^{2}}{γ} {sech}^{2} ( \frac{{D}_{1} μ}{{Δω}_{s}} )$$

where μ is the comb mode number counting away from the pump line, β₂ is the group velocity dispersion coefficient, D₁/2π=19.8 GHz is the cavity FSR and Δωₛ is the comb spectral bandwidth, yielding a maximum line power of about-29 dBm and a total microcomb power of about 0.3 mW. Parameters used for the soliton microcomb power fitting are extracted from the reported Si₃N₄ Euler-bend racetrack microresonator [140]. The group velocity dispersion β₂ is −14.1 fs²/mm, corresponding to D₂/2π=34.9 kHz. The effective nonlinear coefficient is 0.81 W⁻¹ m⁻¹. The microcomb bandwidth is given by δωₛ=2/πδτₛ where δτₛ is approximately 61 ps when the pump laser frequency detuning is maximized with 70 mW power in the bus waveguide.

With the generated 19.8 GHz single-soliton state microcomb, we implement the photonic generation of microwaves using direct photodetection (Discovery Semiconductors, DSC40). The measured single-sideband phase noise at Fourier offset frequencies of >30 kHz reaches a high noise plateau of −104 dBc/Hz measured by a phase noise analyzer (PNA, Rohde & Schwarz, FSW43). This phase noise plateau is limited by photon shot noise [141] due to the low incident optical power on the photodetector (0.1 mA photocurrent).

The Inventors use an Er:Si₃N₄ EDWA to increase the soliton power to 8.4 mW (6.9 dBm), corresponding to an off-chip net gain of 20.1 dB. This results in 3.8 mA photocurrent, with 3.5 dB insertion loss between the chip output and the PD. The amplified soliton is able to deliver a strong microwave signal, resulting in a reduced phase noise for offset frequencies of >10 kHz, reaching-120 dBc/Hz at 100 kHz and −126 dBc/Hz at 1 MHz, respectively. The spectral bumps around 4 kHz offset frequencies is attributed the characteristic laser phase noise (Toptica CTL), while the spectral spikes between 10 kHz and 100 kHz stem from the laser amplitude-to-phase noise conversion observed in prior works [140, 142, 143]. The ‘step-like’ phase noise at offset frequencies above 100 kHz is dominated by the phase noise analyzer noise floor (the dashed dotted line). We would like to note that there appear fluctuations in power of amplified comb lines from 1550 nm to 1650 nm, which stems from the wavelength-dependent enhanced amplification induced by the F-P cavity formed by chip facets. For the case of using a commercial erbium-doped fiber amplifier, the input soliton microcomb is amplified to a similar output power of 6.8 dBm for comparison.

### Transmitter OSNR Budget Estimation for Error Free Short-Reach Transmission:

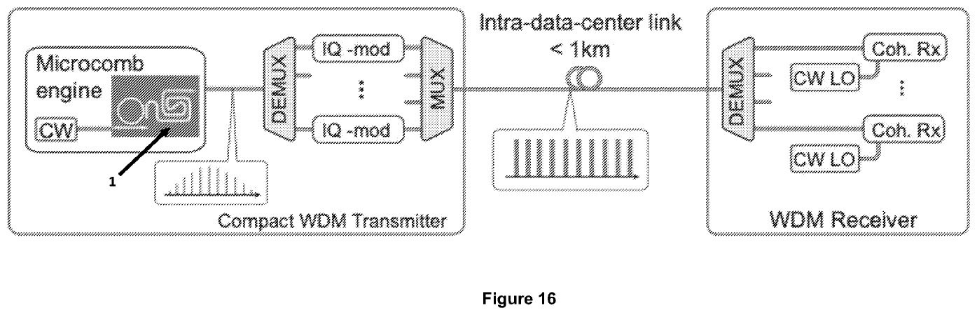

FIG. 16 shows an envisaged short-reach (<1 km) communication application scenario, e.g. intra-data-center commu-nications, using integrated Er:Si₃N₄ EDWAs to amplify the power of soliton microcombs. The theoretical bit error rate (BER) of 16 QAM signals can be analytically calculated from the OSNR, given by [144]

$$BER = \frac{3}{8} erfc \sqrt{\frac{OSNR}{10}} ,$$

where erfc is the complementary error function and OSNR is related to the measured OSNR_{ref} by an optical spectrum analyzer (OSA), expressed by

$$OSNR = \frac{2 {B}_{ref}}{{pB}_{s}} {OSNR}_{ref} ,$$

where B_{ref} and Bₛ correspond to the resolution bandwidth of the OSA and the effective bandwidth of the matched filter at the receiver, p=1 (2) relates to the signal polarization multiplexing. Considering a forward-error correction based on 7% redundancy, an OSNR of >20 dB at the receiver is required to achieve a BER less than the threshold value of 4.5×10⁻³ for 16 quadrature amplitude modulation (QAM) signals at a symbol rate of 40GBd. This sets the minimum optical signal-to-noise ratio (OSNR) requirement for the transmitter output. For short-reach (<1 km) communications with negligible fiber link loss, the output OSNRs (>30 dB) of the demonstrated amplified microcomb by the Er:Si₃N₄ EDWAs can feasibly satisfy the OSNR requirement for the transmitter, allowing to tolerate around 10 dB OSNR penalty from an additional optical amplifier in the link, electronic noise, and nonlinear effects.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments and be given the broadest reasonable interpretation in accordance with the language of the appended claims. The features of any one of the above-described embodiments may be included in any other embodiment described herein.

### REFERENCES

1. S. B. Poole, D. N. Payne, R. J. Mears, M. E. Fermann, R. I. Laming, Journal of Lightwave Technology 4, 870 (1986).
2. R. Mears, L. Reekie, I. Jauncey, D. Payne, Electronics Letters 23, 1026 (1987).
3. P. J. Winzer, D. T. Neilson, A. R. Chraplyvy, Optics Express 26, 24190 (2018).
4. J. R. Becker, P. M., Olsson, A. A., & Simpson, Erbium-Doped Fiber Amplifiers (Elsevier, 1999).
5. C. Xu, F. W. Wise, Nature Photonics 7, 875 (2013).
6. A. Polman, D. C. Jacobson, D. J. Eaglesham, R. C. Kistler, J. M. Poate, Journal of Applied Physics 70, 3778 (1991).
7. A. Polman, Journal of Applied Physics 82, 1 (1997).
8. J. Bradley, M. Pollnau, Laser & Photonics Reviews 5, 368 (2011).
9. G. Nykolak, M. Haner, P. Becker, J. Shmulovich, Y. Wong, IEEE Photonics Technology Letters 5, 1185 (1993).
10. K. Hattori, T. Kitagawa, M. Oguma, Y. Ohmori, M. Horiguchi, Electronics Letters 30, 856 (1994).
11. D. Thomson, et al., Journal of Optics 18, 073003 (2016).
12. D. J. Moss, R. Morandotti, A. L. Gaeta, M. Lipson, Nature Photonics 7, 597 (2013).
13. V. Brasch, et al., Science 351, 357 (2016).
14. J. Liu, et al., Nature Communications 12, 2236 (2021).
15. P. G. Kik, A. Polman, Journal of Applied Physics 93, 5008 (2003).
16. J. Mu, M. Dijkstra, J. Korterik, H. Offerhaus, S. M. García-Blanco, Photonics Research 8, 1634 (2020).
17. J. Ro\ddot{n}n, et al., Nature Communications 10, 1 (2019).
18. H. C. Frankis, et al., Photonics Research 8, 127 (2020).
19. H. Sun, et al., Nature Photonics 11, 589 (2017).
20. M. L. Davenport, et al., IEEE Journal of Selected Topics in Quantum Electronics 22, 78 (2016).
21. K. Van Gasse, R. Wang, G. Roelkens, Optics Express 27, 293 (2019).
22. C. Op de Beeck, et al., Optica 7, 386 (2020).
23. D. E. McCumber, Physical Review 136, 16 (1964).
24. R. C. Giles, E. Desurvire, Journal of Lightwave Technology 9, 271 (1991).
25. T. J. Kippenberg. A. L. Gaeta, M. Lipson, M. L. Gorodetsky, Science361,eaan8083 (2018).
26. C. Bao, et al., Optics Letters 39, 6126 (2014).
27. P. Marin-Palomo, et al., Nature 546, 274 (2017).
28. N. Singh, E. Ippen, F. X. Ka\ddot{r}tner, Optics Express 28, 22562 (2020).
29. H. Bao, et al., Nature Photonics 13, 384 (2019).
30. D. Marpaung, J. Yao, J. Capmany, Nature Photonics 13, 80 (2019).
101. Chrysostomidis, T. et al. 480 Gbps WDM Transmission Through an Al 2 O 3: Er 3+ Waveguide Amplifier. Journal of Lightwave Technology 40, 735-743 (2022). URL https://ieeexplore.ieee.org/document/9582780/.
102. Mu, J., Dijkstra, M., Korterik, J., Offerhaus, H. & García-Blanco, S. M. High-gain waveguide amplifiers in Si 3 N 4 technology via double-layer monolithic integration. Photonics Research 8, 1634 (2020). URL https://www.osapublishing. org/abstract.cfm?URI=prj-8-10-1634.
103. Frankis, H. C. et al. Erbium-doped TeO 2-coated Si 3 N 4 waveguide amplifiers with 5 dB net gain. Photonics Research 8, 127 (2020). URL https://www.osapublishing.org/abstract.cfm?URI=prj-8-2-127.
104. Ronn, J. et al. Ultra-high on-chip optical gain in erbium-based hybrid slot waveguides. Nature Communications 10, 1-9 (2019). URL http://dx.doi.org/10.1038/s41467-019-08369-w.
105. A gazzi, L. et al. Monolithic integration of erbium-doped amplifiers with silicon-on-insulator waveguides. Optics Express 18, 27703 (2010). URL https://www.osapublishing.org/oe/abstract.cfm?uri=oe-18-26-27703.
106. Bonneville, D. B., Frankis, H. C., Wang, R. & Bradley, J. D. B. Erbium-ytterbium co-doped aluminium oxide waveguide amplifiers fabricated by reactive co-sputtering and wet chemical etching. Optics Express 28, 30130 (2020).
107. Vazquez-Cordova, S. A. et al. Erbium-doped spiral amplifiers with 20 dB of net gain on silicon. Optics Express 22, 25993 (2014). URL https://www.osapublishing.org/oe/abstract.cfm?uri=oe-22-21-25993.
108. Van den Hoven, G. N. et al. Net optical gain at 1.53 μm in Er-doped Al₂O₃waveguides on silicon. Applied Physics Letters 68, 1886-1888 (1996). URL http://aip.scitation.org/doi/10.1063/1.116283.
109. Subramanian, A. Z., Murugan, G. S., Zervas, M. N. & Wilkinson, J. S. Spectroscopy, modeling, and performance of erbium-doped Ta 2O 5 Waveguide Amplifiers. Journal of Lightwave Technology 30, 1455-1462 (2012). URL http://ieeexplore.ieee.org/document/6140531/.
110. Vu, K. & Madden, S. Tellurium dioxide Erbium doped planar rib waveguide amplifiers with net gain and 28 dB/cm internal gain. Optics Express 18, 19192 (2010). URL https://www.osapublishing.org/oe/abstract.cfm?uri=oe-18-18-19192https://opg.optica.org/oe/abstract.cfm?uri-oe-18-18-19192.
111. Zhou, J. et al. On-Chip Integrated Waveguide Amplifiers on Erbium-Doped Thin-Film Lithium Niobate on Insulator. Laser & Photonics Reviews 15, 2100030 (2021). URL https://onlinelibrary.wiley.com/doi/10.1002/lpor.202100030.
112. Hattori, K., Kitagawa, T., Oguma, M., Ohmori, Y. & Horiguchi, M. Erbium-doped silica-based waveguide amplifier integrated with a 980/1530 nm WDM coupler. Electronics Letters 30, 856-857 (1994). URL https://digital-library. theiet.org/content/journals/10.1049/el{_}19940596.
113. Barbier, D., Delavaus, J. M., Kevorkian, A., OGastaldo, P. & Jouanno, J. M. Yb/Er Integrated optics amplifiers on phosphate glass in single and double pass configurations. In Optical Fiber Communications Conference, PD3 (OSA, Wash-ington, D.C., 1995). URL https://www.osapublishing.org/abstract.cfm?URI=OFC-1995-PD3https://opg.optica.org/abstract.cfm?URI-OFC-1995-PD3.
114. Nykolak, G., Haner, M., Becker, P., Shmulovich, J. & Wong, Y. Systems evaluation of an Er/sup 3+/− doped planar waveguide amplifier. IEEE Photonics Technology Letters 5, 1185-1187 (1993). URL http://ieeexplore.ieee.org/document/248422/.
115. Della Valle, G. et al. Compact high gain erbium-ytterbium doped waveguide amplifier fabricated by Ag—Na ion ex-change. Electronics Letters 42, 632 (2006). URL https://digital-library.theiet.org/content/journals/10.1049/el{_}20060555.
116. Thomson, R. R., Psaila, N. D., Beecher, S. J. & Kar, A. K. Ultrafast laser inscription of a high-gain Er-doped bismuthate glass waveguide amplifier. Optics Express 18, 13212 (2010). URL https://www.osapublishing.org/oe/abstract.cfm? uri=oe-18-12-13212.
117. Van Gasse, K., Wang, R. & Roelkens, G. 27 dB gain III-V-on-silicon semiconductor optical amplifier with >17 dBm output power. Optics Express 27, 293 (2019). URL https://www.osapublishing.org/abstract.cfm?URI-oe-27-1-293.
118. Davenport, M. L. et al. Heterogeneous silicon/III-V semiconductor optical amplifiers. IEEE Journal of Selected Topics in Quantum Electronics 22, 78-88 (2016). URL http://ieeexplore.ieee.org/document/7516667/.
119. Op de Beeck, C. et al. Heterogeneous III-V on silicon nitride amplifiers and lasers via microtransfer printing. Optica 7, 386 (2020). URL https://www.osapublishing.org/abstract.cfm?URI-optica-7-5-386.
120. Op de Beeck, C. et al. III/V-on-lithium niobate amplifiers and lasers. Optica 8, 1288 (2021). URL https://www.osapublishing.org/abstract.cfm?URI=optica-8-10-1288.
121. Pfeiffer, M. H. P. et al. Photonic Damascene process for integrated high-Q microresonator based nonlinear photonics. Optica 3, 20 (2016). URL https://www.osapublishing.org/abstract.cfm?URI=optica-3-1-20.
122. Pfeiffer, M. H. P. et al. Photonic Damascene process for low-loss, high-confinement silicon nitride waveguides. IEEE Journal of Selected Topics in Quantum Electronics 6, 1-11 (2018). URL https://ieeexplore.ieee.org/document/8393467/.
123. Liu, J. et al. High-yield, wafer-scale fabrication of ultralow-loss, dispersion-engineered silicon nitride photonic circuits. Nature Communications 12, 2236 (2021). URL http://www.nature.com/articles/s41467-021-21973-z.
124. Polman, A., Jacobson, D. C., Eaglesham, D. J., Kistler, R. C. & Poate, J. M. Optical doping of waveguide materials by MeV Er implantation. Journal of Applied Physics 70, 3778-3784 (1991). URL http://aip.scitation.org/doi/10.1063/1.349234.
125 Prtljaga, N. et al. Limit to the erbium ions emission in silicon-rich oxide films by erbium ion clustering. Optical Materials Express 2, 1278 (2012). URL https://opg.optica.org/ome/abstract.cfm?uri=ome-2-9-1278.
126. Felch, S., Current, M. & Taylor, M. Ion Implantation for Semiconductor Devices: The Largest Use of Industrial Acceler-ators. Proceedings of PAC 2013, Pasadena, CA USA. 740-744 (2013). URL https://accelconf.web.cern.ch/pac2013/papers/weyb2.pdf.
127. Ziegler, J. F., Ziegler, M. & Biersack, J. SRIM—The stopping and range of ions in matter (2010). Nuclear Instruments and Methods in Physics Research Section B: Beam Interactions with Materials and Atoms 268, 1818-1823 (2010). URL http://dx.doi.org/10.1016/j.nimb.2010.02.091https://linkinghub.elsevier.com/retrieve/pii/S016 8583X10001862.
128. Liu, J. et al. Frequency-comb-assisted broadband precision spectroscopy with cascaded diode lasers. Optics Letters 41, 3134 (2016). URL https://opg.optica.org/abstract.cfm?URI=ol-41-13-3134.
129. Riemensberger, J. et al. Photonic chip-based continuous-travelling-wave parametric amplifier. arXiv preprint:2107.09582 (2021). URL http://arxiv.org/abs/2107.09582.
130. Van den Hoven, G. N. et al. Upconversion in Er-implanted Al 2 O 3 waveguides. Journal of Applied Physics 79, 1258-1266 (1996). URL http://aip.scitation.org/doi/10.1063/1.361020.
131. Giles, R. C. & Desurvire, E. Modeling Erbium-Doped Fiber Amplifiers. Journal of Lightwave Technology 9, 271-283 (1991). URL http://ieeexplore.ieee.org/document/65886/.
132. Becker, P. M., Olsson, A. A., & Simpson, J. R. Erbium-Doped Fiber Amplifiers (Elsevier, 1999). URL https://linkinghub.elsevier.com/retrieve/pii/B9780120845903X50005.
133 Kik, P. G. & Polman, A. Cooperative upconversion as the gain-limiting factor in Er doped miniature Al₂O₃optical waveguide amplifiers. Journal of Applied Physics 93, 5008-5012 (2003). URL http://aip.scitation.org/doi/10.1063/1.1565697.
134. Arahira, S., Watanabe, K., Shinozaki, K. & Ogawa, Y. Successive excited-state absorption through a multistep process in highly Er\hat{ }3+-doped fiber pumped by a 148-μm laser diode. Optics Letters 17, 1679 (1992). URL https://opg.optica.org/abstract.cfm?URI=ol-17-23-1679.
135. Kir'yanov, A. V., Barmenkov, Y. O., Sandoval-Romero, G. E. & Escalante-Zarate, L. Er Concentration Effects in Commercial Erbium-Doped Silica Fibers Fabricated Through the MCVD and DND Technologies. IEEE Journal of Quantum Electronics 49, 511-521 (2013). URL http://ieeexplore.ieee.org/document/6502181/.
136. Feuchter, T. & Thirstrup, C. High precision planar waveguide propagation loss measurement technique using a Fabry-Perot cavity. IEEE Photonics Technology Letters 6, 1244-1247 (1994). URL http://ieeexplore.ieee.org/document/329652/.
137. Derickson, D. Fiber optic test and measurement. Fiber optic test and measurement/edited by Dennis Derickson. Upper Saddle River (1998).
138. Guo, H. et al. Universal dynamics and deterministic switching of dissipative Kerr solitons in optical microresonators. Nature Physics 13, 94-102 (2017). URL http://www.nature.com/articles/nphys3893.
139. Herr, T. et al. Temporal solitons in optical microresonators. Nature Photonics 8, 145-152 (2014). URL http://www.nature.com/articles/nphoton.2013.343.
140. Ji, X. et al. Compact, spatial-mode-interaction-free, ultralow-loss, nonlinear photonic integrated circuits. arXiv preprint: 2109.06764 (2021). URL http://arxiv.org/abs/2109.06764.
141. Liang, W. et al. High spectral purity Kerr frequency comb radio frequency photonic oscillator. Nature Communications 6, 7957 (2015). URL http://www.nature.com/articles/ncomms8957.
142. Lucas, E. et al. Ultralow-noise photonic microwave synthesis using a soliton microcomb-based transfer oscillator. Nature Communications 11, 374 (2020). URL http://www.nature.com/articles/s41467-019-14059-4.
143. Liu, J. et al. Photonic microwave generation in the X- and K-band using integrated soliton microcombs. Nature Photonics 14, 486-491 (2020). URL http://dx.doi.org/10.1038/s41566-020-0617-x.
144. Marin-Palomo, P. et al. Microresonator-based solitons for massively parallel coherent optical communications. Nature 546, 274-279 (2017). URL http://www.nature.com/articles/nature22387.

The entire contents of each reference being fully incorporated herein by reference.

1-89. (canceled)

90. A photonic integrated circuit waveguide amplifier comprising:
at least one embedding cladding layer, and
at least one rare-earth ion implanted material comprising silicon nitride embedded in the at least one embedding cladding material or layer, the at least one rare-earth ion implanted material comprising silicon nitride defining a waveguide core enclosed by the at least one embedding cladding material or layer.

91. The photonic integrated circuit waveguide amplifier according to claim 90, wherein the waveguide core comprising silicon nitride extends inside the at least one embedding cladding layer and away from a support surface to define an outer or upper surface substantially at a same level as that of an outer or upper surface defined by the at least one embedding cladding layer.

92. The photonic integrated circuit waveguide amplifier according to claim 90, wherein the at least one embedding cladding layer extends away from a support surface to define an outer or upper cladding surface located at a cladding height from the support surface, and wherein the waveguide core comprising silicon nitride extends inside the at least one embedding cladding layer and away from the support surface to define an outer or upper surface located at a height level that has a value between 0.01 and 1.0 times the cladding height, the height values being measured from the support surface.

93. The photonic integrated circuit waveguide amplifier according to claim 90, wherein the at least one embedding cladding layer defines at least one recess or depression having a recess height, and the waveguide core comprising silicon nitride fills the at least one recess or depression to define an outer or upper surface located at a height level that has a value between 0.8 and 1.1 times the recess height, the height values being measured from a floor of the recess.

94. The photonic integrated circuit waveguide amplifier according to claim 90, wherein the at least one rare-earth ion implanted material comprising silicon nitride includes an outer or upper silicon nitride surface non-directly contacting the cladding layer that is bowed or protrudes outwards away from the cladding layer.

95. The photonic integrated circuit waveguide amplifier according to claim 90, wherein the at least one embedding cladding layer defines or comprises at least one supporting structure in contact with an upper half and a lower half of the waveguide core comprising silicon nitride, wherein the at least one supporting structure extends laterally from the upper half and the lower half of the waveguide core and extends a distance therefrom that is greater than 0.25 times a cross-sectional width of the waveguide core.

96. The photonic integrated circuit waveguide amplifier according to claim 90, wherein the at least one rare-earth ion implanted material comprising silicon nitride defines an inner cross-sectional width W_{I} and an outer cross-sectional width Wₒ, wherein the inner cross-sectional width W_{I} is shorter than the outer cross-sectional width Wₒ.

97. The photonic integrated circuit waveguide amplifier according to claim 90, wherein the at least one rare-earth ion implanted material comprising silicon nitride defines or includes first and second outwardly diverging lateral side walls, and the at least one embedding cladding layer defines or includes first and second outwardly diverging lateral side walls, wherein the first and second outwardly diverging lateral side walls of the at least one embedding cladding layer respectively mechanically support the first and second outwardly diverging lateral side walls of the at least one rare-earth ion implanted material comprising silicon nitride.

98. The photonic integrated circuit waveguide amplifier according to claim 96, further including at least one passive or non-amplification component including an embedded non-ion implanted material comprising silicon nitride connected to the embedded rare-earth ion implanted silicon nitride material or layer, the passive or non-amplification component having a width ratio expressed as a fraction Wₒ/W_{I} of the embedded non-ion implanted material comprising silicon nitride that is less than that of the embedded rare-earth ion implanted material comprising silicon nitride.

99. The photonic integrated circuit waveguide amplifier according to claim 90, wherein the implanted rare earth ions are located at least at mid-distance inside the at least one rare-earth ion implanted material comprising silicon nitride.

100. The photonic integrated circuit waveguide amplifier according to claim 90, wherein the at least one rare-earth ion implanted material comprising silicon nitride is configured or dimensioned to support a fundamental transverse electric optical waveguide mode in a cross-sectional direction of the waveguide amplifier,
wherein the implanted rare earth ions are located in the at least one rare-earth ion implanted material comprising silicon nitride to spatially overlap with the fundamental transverse electric optical waveguide mode,
and wherein the spatial overlap is at least 25%.

101. The photonic integrated circuit waveguide amplifier according to claim 90, wherein at least 85% of the implanted rare earth ions are located in the at least one rare-earth ion implanted material comprising silicon nitride to be optically active in amplification.

102. The photonic integrated circuit waveguide amplifier according to claim 90, wherein the rare-earth ion implanted concentration in the at least one rare-earth ion implanted material comprising silicon nitride is between 0.1×10²⁰ cm⁻³ and 3.5×10²⁰ cm⁻³.

103. The photonic integrated circuit waveguide amplifier according to claim 90, wherein the at least one rare-earth ion implanted material comprising silicon nitride hosts between 0.1 and 0.3 atom % of rare-earth atoms.

104. The photonic integrated circuit waveguide amplifier according to claim 90, wherein the at least one embedding cladding layer defines or includes a stress release recess structure comprising a plurality of indentations formed in the at least one embedding cladding layer.

105. A photonic integrated circuit waveguide amplifier fabrication method comprising:
providing at least one embedding cladding layer comprising at least one material comprising silicon nitride embedded or buried inside the at least one embedding cladding layer; and
carrying out rare-earth ion implantation by ion irradiation of at least one surface of the at least one embedded or buried material comprising silicon nitride to form at least one rare-earth ion implanted material comprising silicon nitride embedded or buried in the at least one embedding cladding layer, the at least one material comprising silicon nitride defining a waveguide core.

106. The method according to claim 105, wherein rare-earth ion implantation is carried out by ion irradiation of at least one directly exposed or uncovered surface of the at least one embedded or buried material comprising silicon nitride to form the at least one rare-earth ion implanted material comprising silicon nitride embedded or buried in the at least one embedding cladding layer.

107. The method according to claim 105, wherein rare-earth ion implantation is carried out by ion irradiation through at least one cladding layer provided or deposited on the at least one surface of the at least one embedded or buried material comprising silicon nitride to form the at least one rare-earth ion implanted material comprising silicon nitride embedded or buried in the at least one embedding cladding layer.

108. The method according to claim 107, wherein the at least one cladding layer provided or deposited directly on the at least one surface of the at least one embedded or buried material comprising silicon nitride.

109. The method according to claim 105, further including annealing the at least one rare-earth ion implanted material comprising silicon nitride embedded or buried in the at least one embedding cladding layer to reduce implantation defect optical losses
